(19) United States
(12) Patent Application Publication
(10) Pub. No.: US 2026/0054913 A1
(43) Pub. Date: Feb. 26, 2026

(54) CONTACT LENSES HAVING CATIONIC MONOMERS OR CATIONIC POLYMERS FOR RELEASING COMFORT AGENTS

(71) Applicant: Bausch + Lomb Ireland Limited, Dublin (IE)

(72) Inventor: Alok Kumar Awasthi, Pittsford, NY (US)

(21) Appl. No.: 19/297,375

(22) Filed: Aug. 12, 2025

Related U.S. Application Data
(60) Provisional application No. 63/685,091, filed on Aug. 20, 2024.

(51) Int. Cl. B65D 85/38; C08F 220/06; C08F 230/02

(52) U.S. Cl. CPC B65D 85/38; C08F 220/06; C08F 230/02; B65D 2585/545

(57) ABSTRACT

A packaging system for the storage of a contact lens comprising a sealed container containing an unused contact lens including one or more anionic comfort agents associated with a cationic monomer or a cationic polymer immersed in an aqueous packaging solution, wherein the aqueous packaging solution has an osmolality of at least about 200 mOsm/kg, a pH of about 6 to about 9 and is sterilized.

### PRIORITY CLAIM

The present application claims priority to U.S. Provisional Patent Application Ser. No. 63/685,091, entitled “Contact Lenses having Cationic Monomers or Cationic Polymers for Releasing Comfort Agents,” filed Aug. 20, 2024, the content of which is incorporated by reference herein in its entirety.

### BACKGROUND

It is highly desirable that contact lenses be as comfortable as possible for wearers. Manufacturers of contact lenses are continually working to improve the comfort of the lenses. Nevertheless, many people who wear contact lenses still experience dryness or eye irritation throughout the day and particularly towards the end of the day. An insufficiently wetted lens at any point in time will cause significant discomfort to the lens wearer. Although wetting drops can be used as needed to alleviate such discomfort, it would certainly be desirable if such discomfort did not arise in the first place.

### SUMMARY

In accordance with an illustrative embodiment, a contact lens comprises one or more anionic comfort agents associated with a cationic monomer or a cationic polymer.

In accordance with yet another illustrative embodiment, a method for making a contact lens comprises one or more anionic comfort agents associated with a cationic monomer or a cationic polymer comprises:
(a) providing a contact lens-forming monomeric mixture comprising (i) one or more contact lens-forming monomers, and (ii) one of one or more anioinic comfort agents or one of a cationic monomer, a cationic polymer, a cationic-forming monomer or a cationic-forming polymer,
(b) subjecting the contact lens-forming monomeric mixture to polymerization conditions to provide a polymerized contact lens, and
(c) soaking the polymerized contact lens in a buffered solution comprising the other one of the one or more anioinic comfort agents or the one of a cationic monomer, a cationic polymer, a cationic-forming monomer or a cationic-forming polymer.

In accordance with still yet another illustrative embodiment, a packaging system for the storage of a contact lens comprises a sealed container containing an unused contact lens comprising one or more anionic comfort agents associated with a cationic monomer or a cationic polymer immersed in an aqueous packaging solution, wherein the aqueous packaging solution has an osmolality of at least about 200 mOsm/kg, a pH of about 6 to about 9 and is sterilized.

In accordance with still yet a further illustrative embodiment, a method of preparing a package comprises a storable, sterile contact lens, the method comprising:
(a) immersing a contact lens which is a polymerization product of a contact lens-forming monomeric mixture comprising (i) one or more contact lens-forming monomers, and (ii) one of one or more anioinic comfort agents or one of a cationic monomer, a cationic polymer, a cationic-forming monomer or a cationic-forming polymer in an aqueous packaging solution comprising the other one of the one or more anioinic comfort agents or the one of a cationic monomer, a cationic polymer, a cationic-forming monomer or a cationic-forming polymer, wherein the aqueous packaging solution has an osmolality of at least about 200 mOsm/kg and a pH in the range of about 6 to about 9,
(b) packaging the aqueous packaging solution and the unused contact lens in a manner preventing contamination of the unused contact lens by microorganisms, and
(c) sterilizing the packaged aqueous solution and the unused contact lens.

### DETAILED DESCRIPTION

Various illustrative embodiments described herein include contact lenses having one or more anionic comfort agents associated with a cationic monomer or a cationic polymer, methods for making the contact lenses and packaging systems containing the contact lenses having the one or more anionic comfort agents associated with the cationic monomer or the cationic polymer.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While compositions and processes are described in terms of “comprising” various components or steps, the compositions and processes can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

In the field of contact lenses, various physical and chemical properties such as, for example, oxygen permeability, wettability, material strength and stability, are but a few of the factors that must be carefully balanced in order to provide a useable contact lens. For example, if the contact lens is not sufficiently wettable, it does not remain lubricated and therefore cannot be worn comfortably in the eye. Thus, contact lenses need to be as comfortable as possible for wearers.

Manufacturers of contact lenses are continually working to improve the comfort of the lenses. For example, the manufacturers of contact lenses may add one or more comfort agents to the contact lenses or in the aqueous packaging solution to improve contact lens comfort. When the lens is placed on the eye, the comfort agents release to the ocular surface. However, it has been a challenge to achieve controlled release of comfort agents during the course of wearing a contact lens because the comfort agents are either trapped inside the lens materials with limited release or demonstrate a burst release instead of the desired controlled release.

The non-limiting illustrative embodiments disclosed herein overcome the foregoing drawbacks by providing contact lenses having one or more anionic comfort agents associated with a cationic monomer or a cationic polymer. By associating the one or more anionic comfort agents with the cationic monomer it has unexpectedly been discovered that the one or more anionic comfort agents will have a slower release over time leading to extended comfort by the wearer. For example, the presence of the cationic monomer or a cationic polymer in the contact lens leads to interchain non-covalent interactions with the one or more anionic comfort agents present in the contact lens. The interchain non-covalent interactions result in a sustained release of the one or more anionic comfort agents leading to improved comfort to the wearer.

As used herein, the term “contact lens” refers to contact lenses that reside in or on the eye. These lenses can provide optical correction, wound care, drug delivery, diagnostic functionality or cosmetic enhancement or effect or a combination of these properties. Suitable contact lenses include, for example, contact lenses such as soft contact lenses, e.g., a soft, hydrogel lens; soft, non-hydrogel lens and the like, hard contact lenses, e.g., a hard, gas permeable lens material, a hybrid lens and the like. A contact lens can be in a dry state or a wet state. A “dry state” refers to a soft contact lens in a state prior to hydration or the state of a hard lens under storage or use conditions. A “wet state” refers to a soft contact lens in a hydrated state. As is understood by one skilled in the art, a contact lens is considered to be “soft” if it can be folded back upon itself without breaking.

The contact lens according to the non-limiting illustrative embodiments disclosed herein can be any material known in the art capable of forming a contact lens as described above. In one embodiment, contact lenses include lenses which are formed from materials not hydrophilic per se. Such contact lenses are formed from materials known in the art and include, by way of example, polysiloxanes, perfluoropolyethers, fluorinated poly(meth)acrylates or equivalent fluorinated polymers derived, e.g., from other polymerizable carboxylic acids, polyalkyl (meth)acrylates or equivalent alkylester polymers derived from other polymerizable carboxylic acids, or fluorinated polyolefins, such as fluorinated ethylene propylene polymers, or tetrafluoroethylene, preferably in combination with a dioxol, e.g., perfluoro-2,2-dimethyl-1,3-dioxol. Representative examples of suitable bulk materials include, but are not limited to, Lotrafilcon A, Neofocon, Pasifocon, Telefocon, Silafocon, Fluorsilfocon, Paflufocon, Silafocon, Elastofilcon, Fluorofocon or Teflon AF materials, such as Teflon AF 1600 or Teflon AF 2400 which are copolymers of about 63 to about 73 mol % of perfluoro-2,2-dimethyl-1,3-dioxol and about 37 to about 27 mol % of tetrafluoroethylene, or of about 80 to about 90 mol % of perfluoro-2,2-dimethyl-1,3-dioxol and about 20 to about 10 mol % of tetrafluoroethylene.

In non-limiting illustrative embodiments, as may be combined with one or more of the preceding paragraphs, the contact lenses described herein can be obtained from a polymerization product of a contact lens-forming monomeric mixture. In some embodiments, a contact lens-forming monomeric mixture can include one or more hydrophilic monomers. Suitable one or more hydrophilic monomers include, for example, unsaturated carboxylic acids, acrylamides, vinyl lactams, poly(alkylencoxy)(meth)acrylates, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include methacrylic acid, acrylic acid and the like and mixtures thereof. Representative examples of amides include alkylamides such as N,N-dimethylacrylamide, N,N-dimethylmethacrylamide and the like and mixtures thereof. Representative examples of cyclic lactams include N-vinyl-2-pyrrolidone, N-vinyl caprolactam, N-vinyl-2-piperidone and the like and mixtures thereof. Representative examples of hydroxyl-containing (meth)acrylates include 2-hydroxyethyl methacrylate, glycerol methacrylate and the like and mixtures thereof. Representative examples of functionalized poly(alkene glycols) include poly(diethylene glycols) of varying chain length containing monomethacrylate or dimethacrylate end caps. In one embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. Mixtures of the foregoing hydrophilic monomers can also be used in the contact lens-forming monomeric mixtures herein.

In non-limiting illustrative embodiments, as may be combined with one or more of the preceding paragraphs, the one or more hydrophilic monomers can be present in the contact lens-forming monomeric mixture in an amount ranging from about 30 wt. % to about 90 wt. %, based on the total weight of the contact lens-forming monomeric mixture. In another illustrative embodiment, the one or more hydrophilic monomers can be present in the contact lens-forming monomeric mixture in an amount ranging from about 45 wt. % to about 75 wt. %, based on the total weight of the contact lens-forming monomeric mixture. In another illustrative embodiment, the one or more hydrophilic monomers can be present in the contact lens-forming monomeric mixture in an amount ranging from greater than or equal to about 50 wt. % to about 75 wt. %, based on the total weight of the contact lens-forming monomeric mixture.

In non-limiting illustrative embodiments, as may be combined with one or more of the preceding paragraphs, the contact lens-forming monomeric mixture can further include one or more hydrophobic monomers. Suitable hydrophobic monomers include ethylenically unsaturated hydrophobic monomers such as, for example, (meth)acrylate-containing hydrophobic monomers, N-alkyl (meth)acrylamide-containing hydrophobic monomers, alkyl vinylcarbonate-containing hydrophobic monomers, alkyl vinylcarbamate-containing hydrophobic monomers, fluoroalkyl (meth)acrylate-containing hydrophobic monomers, N-fluoroalkyl (meth)acrylamide-containing hydrophobic monomers, N-fluoroalkyl vinylcarbonate-containing hydrophobic monomers, N-fluoroalkyl vinylcarbamate-containing hydrophobic monomers, silicone-containing (meth)acrylate-containing hydrophobic monomers, (meth)acrylamide-containing hydrophobic monomers, vinyl carbonate-containing hydrophobic monomers, vinyl carbamate-containing hydrophobic monomers, styrenic-containing hydrophobic monomers, polyoxypropylene (meth)acrylate-containing hydrophobic monomers and the like and mixtures thereof.

In a non-limiting illustrative embodiment, the one or more hydrophobic monomers can be represented by the structure of Formula I:

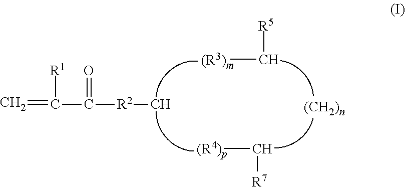

wherein R¹ is methyl or hydrogen; R² is-O— or —NH—; R³ and R⁴ are independently a divalent radical selected from the group consisting of —CH₂—, —CHOH— and —CHR⁶—; R⁵ and R⁶ are independently a branched C₃-C₈ alkyl group; R⁷ is hydrogen or —OH; n is an integer of at least 1, and m and p are independently 0 or an integer of at least 1, provided that the sum of m, p and n is 2, 3, 4 or 5.

Representative examples of one or more hydrophobic monomers represented by the structure of Formula I include, but are not limited to, 4-t-butyl-2-hydroxycyclohexyl methacrylate (TBE); 4-t-butyl-2-hydroxycyclopentyl methacrylate; 4-t-butyl-2-hydroxycyclohexyl methacrylamide (TBA); 6-isopentyl-3-hydroxycyclohexyl methacrylate; 2-isohexyl-5-hydroxycyclopentyl methacrylamide, 4-t-butylcyclohexyl methacrylate, isobornyl methacrylate, adamantyl methacrylate, n-butyl methacrylate, n-hexyl methacrylate, lauryl methacrylate, benzyl methacrylate, and the like. In one embodiment, one or more hydrophobic monomers include compounds of Formula I wherein R³ is —CH₂—, m is 1 or 2, p is 0, and the sum of m and n is 3 or 4.

In non-limiting illustrative embodiments, as may be combined with one or more of the preceding paragraphs, the one or more hydrophobic monomers can be present in the contact lens-forming monomeric mixture in an amount ranging from about 0.5 wt. % to about 25 wt. %, based on the total weight of the contact lens-forming monomeric mixture. In another illustrative embodiment, the one or more hydrophobic monomers will be present in the contact lens-forming monomeric mixture in an amount ranging from about 1 wt. % to about 10 wt. %, based on the total weight of the contact lens-forming monomeric mixture.

In non-limiting illustrative embodiments, as may be combined with one or more of the preceding paragraphs, the contact lens-forming monomeric mixture can further include one or more crosslinking agents. Suitable crosslinking agents for use herein are known in the art. In illustrative embodiments, the one or more crosslinking agents are bi- or polyfunctional crosslinking agents comprising two or more reactive functional groups. In an embodiment, the one or more crosslinking agents have at least two polymerizable functional groups. Representative examples of crosslinking agents include divinylbenzene, allyl methacrylate, ethyleneglycol dimethacrylate, tetraethyleneglycol dimethacrylate, 1,4-butanediol diglycidyl ether, polyethyleneglycol dimethacrylate, vinyl carbonate derivatives of the glycol dimethacrylates, and methacryloxyethyl vinylcarbonate. However, other crosslinking agents are contemplated and the foregoing list is merely exemplary.

In non-limiting illustrative embodiments, as may be combined with one or more of the preceding paragraphs, the one or more crosslinking agents are used in the contact lens-forming monomeric mixture in amounts of less than about 5 wt. %, and generally less than about 2 wt. %, e.g., from about 0.1 wt. % to about 5 wt. %, or from about 0.1 wt. % to about 2 wt. %, based on the total weight of the contact lens-forming monomeric mixture.

In another embodiment, contact lenses include lenses which are formed from materials which are amphiphilic segmented copolymers containing at least one hydrophobic segment and at least one hydrophilic segment which are linked through a bond or a bridge member.

It is particularly useful to employ biocompatible materials herein including both soft and rigid materials commonly used for contact lenses. In general, non-hydrogel materials are hydrophobic polymeric materials that do not contain water in their equilibrium state. Typical non-hydrogel materials comprise silicone acrylics, such as those formed bulky silicone monomer (e.g., tris(trimethylsiloxy) silylpropyl methacrylate, commonly known as “TRIS” monomer), methacrylate end-capped poly(dimethylsiloxane) prepolymer, or silicones having fluoroalkyl side groups (polysiloxanes are also commonly known as silicone polymers).

On the other hand, hydrogel materials comprise hydrated, cross-linked polymeric systems containing water in an equilibrium state. Hydrogel materials contain about 5 wt. % water or more (up to, for example, about 80 wt. %). In one embodiment, hydrogel materials, include silicone hydrogel materials. In another embodiment, hydrogel materials include vinyl functionalized polydimethylsiloxanes copolymerized with hydrophilic monomers as well as fluorinated methacrylates and methacrylate functionalized fluorinated polyethylene oxides copolymerized with hydrophilic monomers. Representative examples of suitable hydrogel materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

A wide variety of materials can be used herein, and silicone hydrogel contact lens materials are particularly preferred. Silicone hydrogels generally have a water content greater than about 5 wt. % and more commonly between about 10 wt. % to about 80 wt. %. Such materials are usually prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed. Applicable silicone-containing monomers for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

In non-limiting illustrative embodiments, as may be combined with one or more of the preceding paragraphs, the contact lens-forming monomeric mixture can further include one or more silicon-containing monomers. Representative examples of applicable silicon-containing monomers include bulky silicone-containing monomers containing an ethylenically unsaturated reactive end group. The term “bulky” refers to groups of Formulae Ila and IIb that are sterically and/or electronically encumbering, i.e., sterically hindering. In a non-limiting illustrative embodiment, suitable bulky silicone-containing monomers include, for example, a bulky polysiloxanylalkyl (meth)acrylic monomer, a bulky polysiloxanylalkyl carbamate monomer and mixtures thereof. A representative example of a bulky silicone-containing monomer includes a bulky polysiloxanylalkyl (meth)acrylic monomer represented by a structure of Formula Ila:

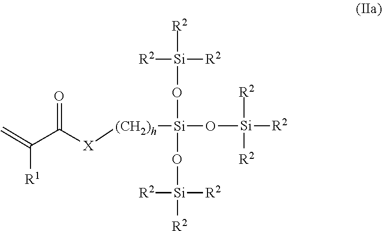

wherein X denotes —O— or —NR³—, where each R³ is hydrogen or a C₁-C₄ alkyl group; R¹ independently denotes hydrogen or methyl; each R² independently denotes a lower alkyl radical such as a C₁-C₆ group, a phenyl radical or a group represented by the following structure:

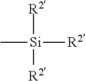

wherein each R^{2′} independently denotes a lower alkyl radical such as a C₁-C₆ group or a phenyl radical; and h is 1 to 10; or a bulky silicone-containing monomer represented by a structure of Formula IIb:

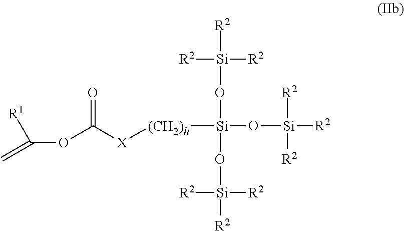

wherein X denotes —NR³— wherein R³ denotes hydrogen or a C₁-C₄ alkyl; R¹ denotes hydrogen or methyl; each R¹⁸ independently denotes a lower alkyl radical such as a C₁-C₆ group, a phenyl radical or a group represented by the following structure:

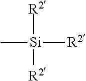

wherein each R^{2′} independently denotes a lower alkyl radical such as a C₁-C₆ group or a phenyl radical; and h is 1 to 10.

Representative examples of bulky silicone-containing monomers include 3-methacryloyloxypropyltris(trimethylsiloxy) silane or tris(trimethylsiloxy) silylpropyl methacrylate, sometimes referred to as TRIS, tris(trimethylsiloxy) silylpropyl vinyl carbamate, sometimes referred to as TRIS-VC, pentamethyldisiloxanyl methylmethacrylate, phenyltetramethyl-disiloxanylethyl acetate, and methyldi (trimethylsiloxy) methacryloxymethyl silane, (3-methacryloxy-2-hydroxy propoxy) propyl bis(trimethyl siloxy)methyl silane, sometimes referred to as Sigma and the like and mixtures thereof. In one embodiment, the bulky silicone-containing monomer is a tris(trialkylsiloxy) silylalkyl methacrylate-containing monomer such as a tris(trimethylsiloxy) silylpropyl methacrylate-containing monomer.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis[4-vinyloxycarbonyloxy) but-1-yl]tetramethyl-disiloxane; 3-(trimethylsilyl) propyl vinyl carbonate; 3-(vinyloxycarbonylthio) propyl-[tris(trimethylsiloxy) silane]; 3-[tris(trimethylsiloxy) silyl]propyl vinyl carbamate; 3-[tris(trimethylsiloxy) silyl]propyl allyl carbamate; 3-[tris(trimethylsiloxy) silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae III and IV:

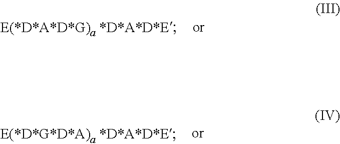

wherein:
D independently denotes an alkyl diradical, an alkyl cycloalkyl diradical, a cycloalkyl diradical, an aryl diradical or an alkylaryl diradical having 6 to about 30 carbon atoms;
G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;
a is at least 1;
A independently denotes a divalent polymeric radical of Formula V:

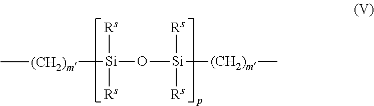

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;
each of E and E′ independently denotes a polymerizable unsaturated organic radical represented by Formula VI:

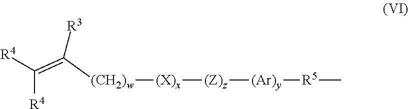

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VII:

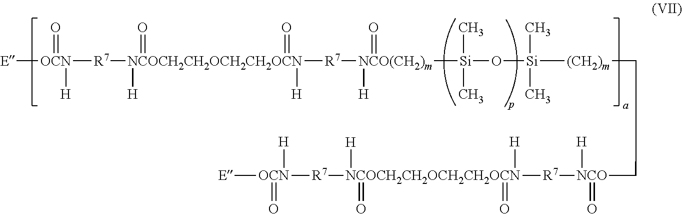

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

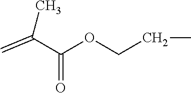

In another illustrative embodiment, a silicone hydrogel material comprises (in bulk, that is, in the contact lens-forming monomeric mixture that is copolymerized) about 5 to about 50 percent, and preferably about 10 to about 25, by weight of one or more silicone macromonomers, about 5 to about 75 percent, and preferably about 30 to about 60 percent, by weight of one or more polysiloxanylalkyl (meth)acrylic monomers, and about 10 to about 50 percent, and preferably about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the illustrative embodiments. The silane macromonomer may be a silicon-containing vinyl carbonate or vinyl carbamate or a polyurethane-polysiloxane having one or more hard-soft-hard blocks and end-capped with a hydrophilic monomer.

Another class of representative silicone-containing monomers includes fluorinated monomers. Such monomers have been used in the formation of fluorosilicone hydrogels to reduce the accumulation of deposits on contact lenses made therefrom, as disclosed in, for example, U.S. Pat. Nos. 4,954,587; 5,010,141 and 5,079,319. Also, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662.

The above silicone materials are merely exemplary, and other materials for use as substrates that can benefit by being coated with the coating composition disclosed herein and have been disclosed in various publications and are being continuously developed for use in contact lenses and other medical devices can also be used.

In non-limiting illustrative embodiments, as may be combined with one or more of the preceding paragraphs, the contact lens-forming monomeric mixture can further include one or more surfactants such as end terminal functionalized surfactants. A suitable end terminal functionalized surfactant includes, by way of example, one or more end terminal functionalized polyethers. Useful polyethers to be end terminal functionalized comprise one or more chains or polymeric components which have one or more (—O—R—) repeat units wherein R is an alkylene or arylene group having 2 to about 6 carbon atoms. The polyethers may be derived from block copolymers formed from different ratio components of ethylene oxide (EO) and propylene oxide (PO). Such polyethers and their respective component segments may include different attached hydrophobic and hydrophilic chemical functional group moieties and segments.

A representative example of a suitable polyether which can be end terminal functionalized is a poloxamer block copolymer. One specific class of poloxamer block copolymers are those available under the trademark Pluronic (BASF Wyandotte Corp., Wyandotte, Mich.). Poloxamers include Pluronics and reverse Pluronics. Pluronics are a series of ABA block copolymers composed of poly(ethylene oxide)-poly(propylene oxide)-poly(ethylene oxide) blocks as generally represented in Formula VIII:

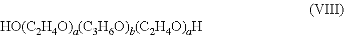

wherein a is independently at least 1 and b is at least 1.

Reverse Pluronics are a series of BAB block copolymers, respectively composed of poly(propylene oxide)-poly(ethylene oxide)-poly(propylene oxide) blocks as generally represented in Formula IX:

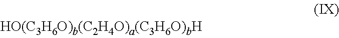

wherein a is at least 1 and b is independently at least 1. The poly(ethylene oxide), PEO, blocks are hydrophilic, whereas the poly(propylene oxide), PPO, blocks are hydrophobic in nature. The poloxamers in each series have varying ratios of PEO and PPO which ultimately determines the hydrophilic-lipophilic balance (HLB) of the material, i.e., the varying HLB values are based upon the varying values of a and b, a representing the number of hydrophilic poly(ethylene oxide) units (PEO) being present in the molecule and b representing the number of hydrophobic poly(propylene oxide) units (PPO) being present in the molecule.

Poloxamers and reverse poloxamers have terminal hydroxyl groups that can be terminal functionalized. An example of a terminal functionalized poloxamer and as discussed hereinbelow is poloxamer dimethacrylate (e.g., Pluronic® F127 dimethacrylate) as disclosed in U.S. Patent Application Publication No. 2003/0044468. Other examples include glycidyl-terminated copolymers of polyethylene glycol and polypropylene glycol as disclosed in U.S. Pat. No. 6,517,933.

Another example of a suitable polyether which can be end terminal functionalized is a poloxamine block copolymer. While the poloxamers and reverse poloxamers are considered to be difunctional molecules (based on the terminal hydroxyl groups), the poloxamines are in a tetrafunctional form, i.e., the molecules are tetrafunctional block copolymers terminating in primary hydroxyl groups and linked by a central diamine. One specific class of poloxamine block copolymers are those available under the trademark Tetronic (BASF). Poloxamines include Tetronic and reverse Tetronics. Poloxamines have the following general structure of Formula X:

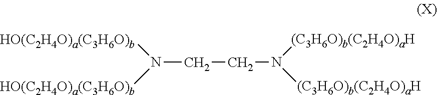

wherein a is independently at least 1 and b is independently at least 1.

The poloxamer and/or poloxamine is functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended device forming monomeric mixture. The term block copolymer as used herein shall be understood to mean a poloxamer and/or poloxamine as having two or more blocks in their polymeric backbone(s).

Generally, selection of the functional end group is determined by the functional group of the reactive molecule(s) in the mixture. For example, if the reactive molecule contains a carboxylic acid group, glycidyl methacrylate can provide a methacrylate end group. If the reactive molecule contains hydroxy or amino functionality, isocyanato ethyl methacrylate or (meth)acryloyl chloride can provide a methacrylate end group and vinyl chloro formate can provide a vinyl end group. A wide variety of suitable combinations of ethylenically unsaturated end groups and reactive molecules will be apparent to those of ordinary skill in the art. For example, the functional group may comprise a moiety selected from amine, hydrazine, hydrazide, thiol (nucleophilic groups), carboxylic acid, carboxylic ester, including imide ester, orthoester, carbonate, isocyanate, isothiocyanate, aldehyde, ketone, thione, alkenyl, acrylate, methacrylate, acrylamide, sulfone, maleimide, disulfide, iodo, epoxy, sulfonate, thiosulfonate, silane, alkoxysilane, halosilane, and phosphoramidate. More specific examples of these groups include succinimidyl ester or carbonate, imidazolyl ester or carbonate, benzotriazole ester or carbonate, p-nitrophenyl carbonate, vinyl sulfone, chloroethylsulfone, vinylpyridine, pyridyl disulfide, iodoacetamide, glyoxal, dione, mesylate, tosylate, and tresylate. Also included are other activated carboxylic acid derivatives, as well as hydrates or protected derivatives of any of the above moieties (e.g., aldehyde hydrate, hemiacetal, acetal, ketone hydrate, hemiketal, ketal, thioketal, thioacetal). Preferred electrophilic groups include succinimidyl carbonate, succinimidyl ester, maleimide, benzotriazole carbonate, glycidyl ether, imidazoyl ester, p-nitrophenyl carbonate, acrylate, tresylate, aldehyde, and orthopyridyl disulfide.

Representative examples of reaction sequences by which PEO- and PPO-containing block copolymers can be end-functionalized are provided below.

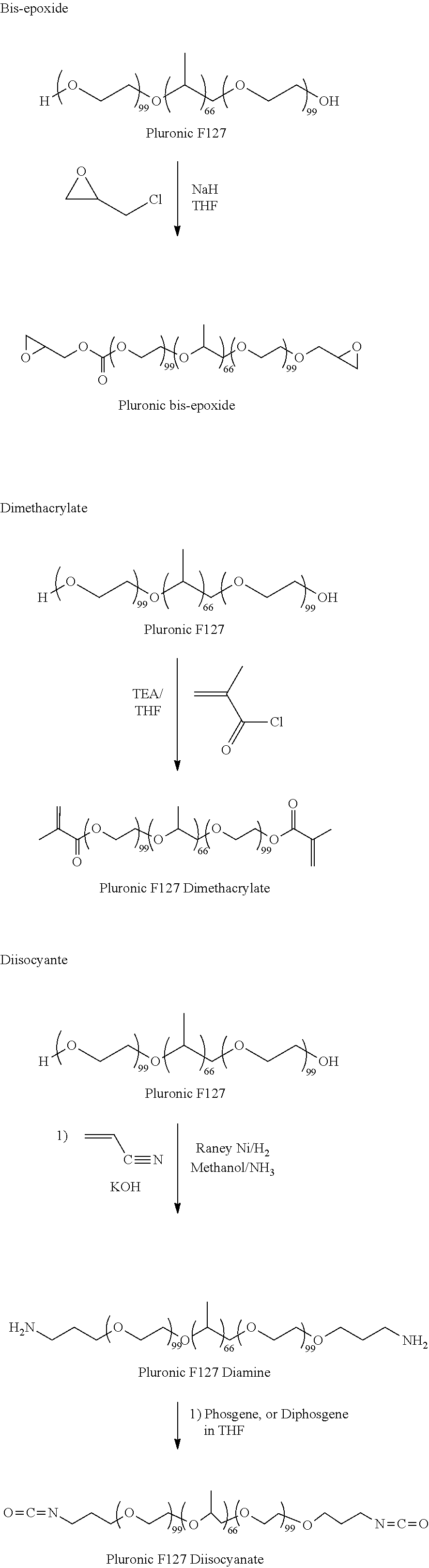

Further provided herein are certain exemplary, but non-limiting, examples of reactions for providing functionalized termini for PEO- and PPO-containing block copolymers. It is to be understood that one of ordinary skill in the art would be able to determine other reaction methods without engaging in an undue amount of experimentation. It should also be understood that any particular block copolymer molecule shown is only one chain length of a polydispersed population of the referenced material.

In an illustrative embodiment, the contact lens-forming monomeric mixture includes one or more of PEO- and PPO-containing block copolymers. An example of such a copolymer that can be used in monomeric mixture is Pluronic® F127, a block copolymer having the structure [(polyethylene oxide)₉₉-(polypropylene oxide)₆₆-(polyethylene oxide)₉₉]. The terminal hydroxyl groups of the copolymer are functionalized to allow for the reaction of the copolymer with other ophthalmic device forming monomers. Another example includes Pluronic 407 dimethacrylate having the following structure:

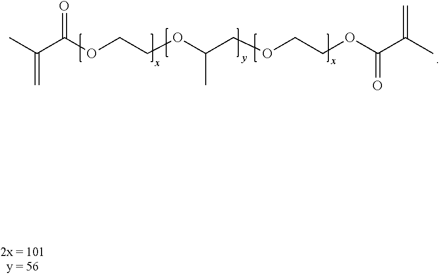

In an illustrative embodiment, an end terminal functionalized surfactant is selected from the group consisting of poloxamers having at least one end terminal functionalized, reverse poloxamers having at least one end terminal functionalized, poloxamines having at least one end terminal functionalized, reverse poloxamines having at least one end terminal functionalized and mixtures thereof.

In non-limiting illustrative embodiments, as may be combined with one or more of the preceding paragraphs, the surfactants can be present in the contact lens-forming monomeric mixture in an amount ranging from about 0.01 wt. % to about 20 wt. %, based on the total weight of the contact lens-forming monomeric mixture. In another illustrative embodiment, the surfactants can be present in the contact lens-forming monomeric mixture in an amount ranging from about 1 wt. % to about 10 wt. %, based on the total weight of the contact lens-forming monomeric mixture.

In non-limiting illustrative embodiments, as may be combined with one or more of the preceding paragraphs, the contact lens-forming monomeric mixture can further include a reactive (polymerizable) ultraviolet (UV) light absorber and/or a reactive blue-light absorber. Suitable reactive UV light absorbers can be any known reactive UV absorber. In non-limiting illustrative embodiments, suitable reactive UV light absorbers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d][1,2,3]triazol-2-yl) phenoxy)ethyl methacrylate.

In one illustrative embodiment, suitable UV light absorbers include, for example, one or more compounds of the following formulae:

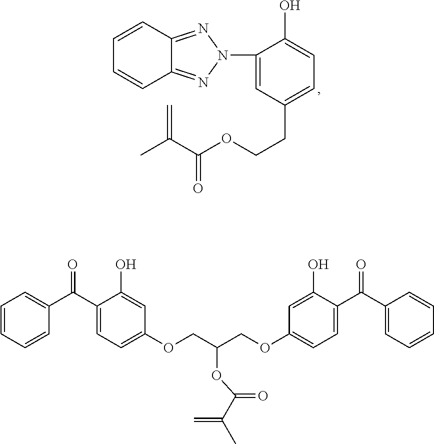 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1[(4-benzoyl3-hydroxyphenoxy)methyl ester),

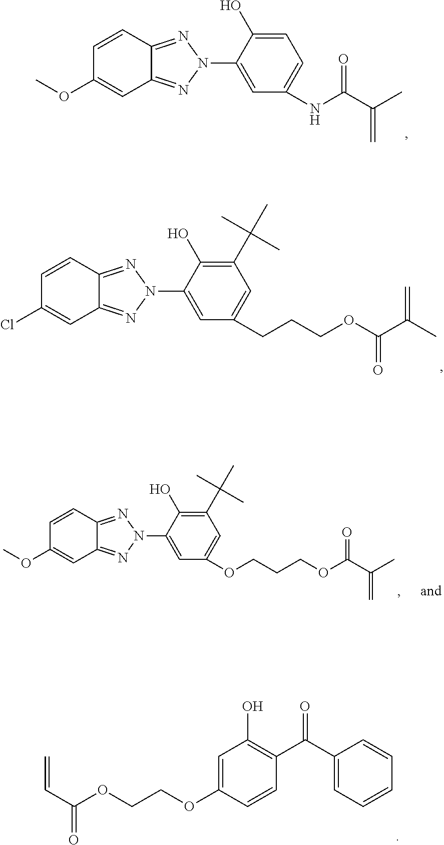

These compounds are merely illustrative and not intended to be limiting. Any known UV blocker or later developed UV blocker are contemplated for use herein.

In illustrative embodiments, the UV light absorbers can be present in the contact lens-forming monomeric mixture in an amount ranging from about 0.1 wt. % to about 5 wt. %, based on the total weight of the contact lens-forming monomeric mixture. In another illustrative embodiment, the UV light absorbers can be present in the contact lens-forming monomeric mixture in an amount ranging from about 1.5 wt. % to about 2.5 wt. %, based on the total weight of the contact lens-forming monomeric mixture. In yet another non-limiting illustrative embodiment, the UV light absorbers can be present in the contact lens-forming monomeric mixture in an amount ranging from about 1.5 wt. % to about 2 wt. %, based on the total weight of the contact lens-forming monomeric mixture.

Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference. In one embodiment, a blue-light absorbing dye is N-2-[3-(2′-methylphenylazo)-4-hydroxyphenyl]ethyl methacrylamide. In illustrative embodiments, the blue-light absorbers can be present in the contact lens-forming monomeric mixture in an amount ranging from about 0.005 wt. % to about 1 wt. %, based on the total weight of the contact lens-forming monomeric mixture. In another illustrative embodiment, the blue-light absorbers can be present in the contact lens-forming monomeric mixture in an amount ranging from about 0.01 wt. % to about 1 wt. %, based on the total weight of the contact lens-forming monomeric mixture.

The contact lens-forming monomeric mixtures disclosed herein may further contain, as necessary and within limits not to impair the purpose and effect of the illustrative embodiments disclosed herein, various additives such as an antioxidant, coloring agent, toughening agents and the like and other constituents as is well known in the art.

The contact lenses discussed above can be prepared by polymerizing the contact lens-forming monomeric mixture containing one or more of the monomers discussed above to form a polymerization product that can be subsequently formed into the appropriate shape by, for example, lathing, injection molding, compression molding, cutting and the like. For example, in producing contact lenses, the initial contact lens-forming monomeric mixture may be polymerized in tubes to provide rod-shaped articles, which are then cut into buttons. The buttons may then be lathed into contact lenses.

Alternately, the contact lenses may be cast directly in molds, e.g., polypropylene molds, from the mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the mixtures to be polymerized to a mold, and spinning the mold in a controlled manner while exposing the mixture to a radiation source such as UV light. Static casting methods involve charging the contact lens-forming monomeric mixture between two mold sections, one mold section shaped to form the anterior lens surface and the other mold section shaped to form the posterior lens surface, and curing the mixture while retained in the mold assembly to form a lens, for example, by free radical polymerization of the mixture.

Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat and/or radiation, such as ultraviolet light, visible light, or high energy radiation. A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative UV initiators are those known in the art and include benzoin methyl ether, benzoin ethyl ether, Darocure® 1173, 1164, 2273, 1116, 2959, 3331 (EM Industries) and Irgacure® 651, 184 and 2959 (Ciba-Geigy), 2,2′ Azobis(2-methylpropionitrile) (VAZO 64) and the like. Generally, the initiator will be employed in the mixture at a concentration of about 0.01 to about 5 percent by weight of the total mixture.

Polymerization is generally performed in a reaction medium, such as, for example, a solution or dispersion using a solvent, e.g., water or an alkanol containing from 1 to 4 carbon atoms such as methanol, ethanol or propan-2-ol. Alternatively, a mixture of any of the above solvents may be used.

Generally, polymerization can be carried out for about 15 minutes to about 72 hours, and under an inert atmosphere of, for example, nitrogen or argon. If desired, the resulting polymerization product can be dried under vacuum, e.g., for about 5 to about 72 hours or left in an aqueous solution prior to use.

Polymerization of the contact lens-forming monomeric mixtures will yield a polymer, that when hydrated, preferably forms a hydrogel. When producing a hydrogel lens, the contact lens-forming monomeric mixture may further include at least a diluent that is ultimately replaced with water when the polymerization product is hydrated to form a hydrogel. The amount of diluent used should be less than about 50 wt. %, and in most cases, the diluent content will be less than about 30 wt. %. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol, glycerine, liquid poly(ethylene glycol), alcohols, alcohol/water mixtures, ethylene oxide/propylene oxide block copolymers, low molecular weight linear poly(2-hydroxyethyl methacrylate), glycol esters of lactic acid, formamides, ketones, dialkylsulfoxides, butyl carbitol, and the like and mixtures thereof.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art.

The contact lenses of the illustrative embodiments described herein will further include one or more anionic comfort agents associated with one or more cationic monomers or cationic polymers. In one embodiment, suitable one or more anionic comfort agents include, for example, one or more releasable anionic comfort agents. For example, when the releasable anionic comfort agent is complexed through ionic interaction with the cationic monomer or the cationic polymer (for instance, due to low pH conditions and/or low ionic strength conditions, such as below about 7 pH or below about 6 pH), at that state, the releasable anionic comfort agent itself is an anionic comfort agent or material that is complexed through ionic interaction with cationic portions or molecules that form part of the polymeric lens material. The releasable anionic comfort agent that is complexed through ionic interaction with the cationic monomer or the cationic polymer of the contact lens is released from the contact lens, such as by dissociating under physiological conditions through ionic interaction with the counterions in eye tear. The released anionic comfort agent at that point, generally becomes a salt or ester (e.g., a salt of hyaluronic acid).

In some embodiment, the anionic comfort agent is released over a period of time of about 5 minutes to about 40 hours. In some embodiments, the anionic comfort agent is released over a period of time of about 30 hours to about 40 hours. In some embodiment, the anionic comfort agent is released over a period of about 1 hour to about 28 hours.

In some embodiments, a suitable anionic comfort agent includes a polymer containing carboxylic acid functionality, such as a polymer containing poly(acrylic acid) (PAA). The polymer containing PAA for use herein can have a weight average molecular weight ranging from about 1,000 to about 50,000 Daltons (Da) or from about 3,000 to about 7,000 Da. The weight average molecular weight as used herein can be determined by such methods as SEC and/or by measuring degree of polymerization by NMR.

Representative examples of other polymers containing carboxylic acid functionality include P (vinylpyrrolidinone (VP)-co-acrylic acid (AA)), P(methylvinylether-co-maleic acid), P (acrylic acid-graft-ethyleneoxide), P (acrylic acid-co-methacrylic acid), P (acrylamide-co-AA), P (acrylamide-co-AA), P (AA-co-maleic), and P (butadiene-maleic acid).

In addition to PAA-containing polymers, other anionic comfort agent reactive with a cationic monomer or a cationic polymer include polymers containing sulfonic acid functionality, fumaric acid functionality, maleic acid functionality, and the like.

In some embodiments, suitable anionic comfort agents include, for example, one or more glycosaminoglycans (GAGs). GAGs are a group of polysaccharides built of repeating disaccharide units. Due to high polarity and water affinity, they can be found in many systems of human and animal bodies. For example, GAGs occur on the surface of cells and in the extracellular matrix of animal organisms such as skin, cartilage, and lungs. GAGs each have a chemical structure including a repeating basal disaccharide structure consisting of uronic acid and hexosamine and being optionally sulfated to various degrees. GAGs are mainly classified, depending on the disaccharides constituting them, into three groups: a first group of compounds composed of chondroitin sulfate or dermatan sulfate, a second group of compounds composed of heparan sulfate or heparin, and a third group of hyaluronic acid compounds. For example, the compounds composed of chondroitin sulfate or dermatan sulfate consist of a disaccharide: uronic acid (glucuronic acid or iduronic acid) (β1→3) N-acetylgalactosamine, the compounds composed of heparan sulfate or heparin consist of a disaccharide: uronic acid (glucuronic acid or iduronic acid) (β1→4) N-acetylglucosamine, and the hyaluronic acid consists of a disaccharide: glucuronic acid (β1→3)N-acetylglucosamine. In addition, the structure is highly diverse due to a combination with modification by sulfation.

These GAGs are known as important biological materials having both physicochemical properties derived from characteristic viscoelasticity and biological properties mediated by interactions with various functional proteins, depending on the molecular size and the sulfation pattern.

The GAGs can have reactive functional groups in the polymer backbone such as carboxylate-containing groups, hydroxyl-containing groups, sulfonic acid-containing groups, silicone hydride groups, sulfur-containing groups such as thiols and other groups including polymerizable functionalities such as allylic, vinylic, acrylate, methacylate, methacrylamide etc. In addition, the sugar rings of the GAGs can be opened to form aldehydes for further functionalization. The GAGs for use herein can have a weight average molecular weight ranging from about 10,000 to about 3,000,000 Da in which the lower limit is from about 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about up to 2,800,000 Da, where any of the lower limits can be combined with any of the upper limits.

Hyaluronic acid is a well-known, naturally occurring, water soluble biodegradable polymer composed of two alternatively linked sugars, D-glucuronic acid and N-acetylglucosamine, linked via alternating β-(1,4) and β-(1,3) glycosidic bonds. Hyaluronic acid is a non-sulfated GAG. The polymer is hydrophilic and highly viscous in aqueous solution at relatively low solute concentrations. It often occurs naturally as the sodium salt, sodium hyaluronate or the potassium salt, potassium hyaluronate. Methods of preparing commercially available hyaluronan and salts thereof are well known. Hyaluronan can be purchased from Seikagaku Company, Clear Solutions Biotech, Inc., Pharmacia Inc., Sigma Inc., and many other suppliers HTL Biotechnology, Contipro and Bloomage Biotechnology Corporation. Hyaluronic acid has repeating units of the structure represented by the following formula:

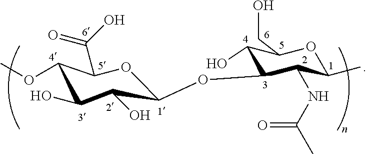

Accordingly, the repeating units in hyaluronic acid can be as follows:

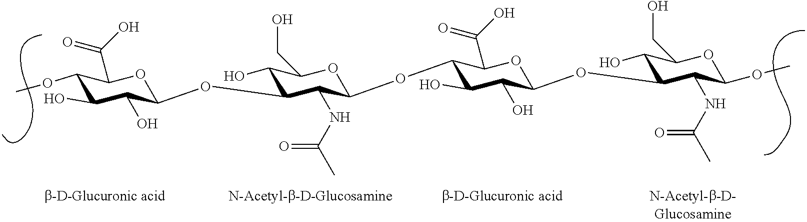

In general, hyaluronic acid or a salt thereof can have from about 2 to about 1,500,000 disaccharide units. In one embodiment, hyaluronic acid or a salt thereof can have a weight average molecular weight ranging from about 10,000 to about 3,000,000 Da in which the lower limit is from about 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about up to 2,800,000 Da, where any of the lower limits can be combined with any of the upper limits.

Chondroitin sulfate is a linear sulfated polysaccharide composed of repeating β-D-glucuronic acid (GlcA) and N-acetyl-β-D-galactosamine (GalNAc) units arranged in the sequence by GlcA-β(1,3)-GalNAc-β(1,4) glycosidic bonds. In one embodiment, chondroitin sulfate can be chondroitin 6-sulfate. In one embodiment, chondroitin sulfate has one or more repeating units of the structure represented by the following formula:

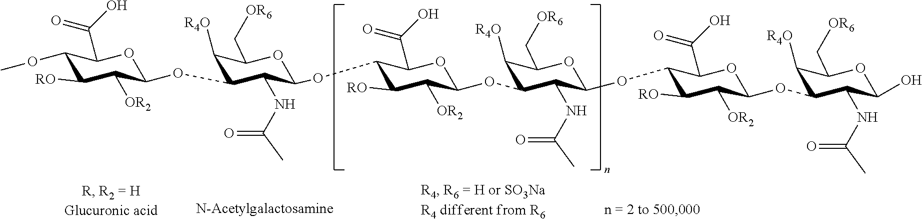

In one illustrative embodiment, chondroitin sulfate has repeating units of the structure represented by the following formula:

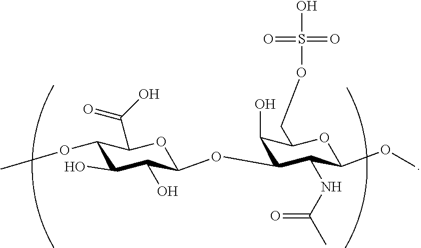

In general, chondroitin sulfate can have from about 2 to about 1,500,000 repeating units. In one embodiment, chondroitin sulfate can have a weight average molecular weight ranging from about 10,000 to about 3,000,000 Da in which the lower limit is from about 5,000, 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about 3,000,000 Da where any of the lower limits can be combined with any of the upper limits or any of the upper limits can be combined with any of the upper limits.

In one illustrative embodiment, dermatan sulfate has repeating units of the structure represented by the following formula:

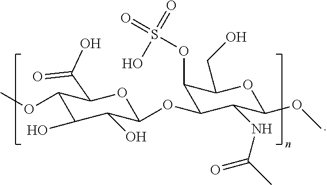

In general, dermatan sulfate can have from about 2 to about 1,500,000 repeating units. In one embodiment, chondroitin sulfate can have a weight average molecular weight ranging from about 10,000 to about 3,000,000 Da in which the lower limit is from about 5,000, 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about 3,000,000 Da where any of the lower limits can be combined with any of the upper limits or any of the upper limits can be combined with any of the upper limits.

In one illustrative embodiment, heparin and heparin sulfate has repeating units of the structure represented by the following formula:

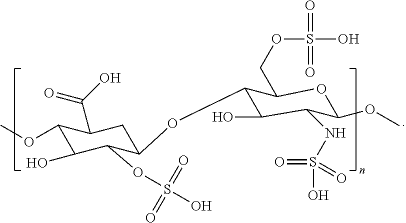

In general, heparin and heparin sulfate can have from about 2 to about 1,500,000 repeating units. In one embodiment, chondroitin sulfate can have a weight average molecular weight ranging from about 10,000 to about 3,000,000 Da in which the lower limit is from about 5,000, 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about 3,000,000 Da where any of the lower limits can be combined with any of the upper limits or any of the upper limits can be combined with any of the upper limits.

In one illustrative embodiment, keratan sulfate has repeating units of the structure represented by the following formula:

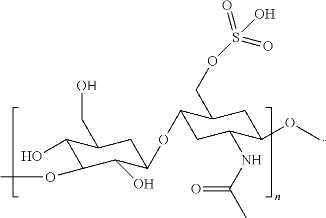

In general, keratan sulfate can have from about 2 to about 1,500,000 repeating units. In one embodiment, chondroitin sulfate can have a weight average molecular weight ranging from about 10,000 to about 3,000,000 Da in which the lower limit is from about 5,000, 10,000, about 20,000, about 30,000, about 40,000, about 50,000, about 60,000, about 70,000, about 80,000, about 90,000, or about 100,000, and the upper limit is about 200,000, about 300,000, about 400,000, about 500,000, about 600,000, about 700,000, about 800,000, about 900,000, about 1,000,000, or about 3,000,000 where any of the lower limits can be combined with any of the upper limits or any of the upper limits can be combined with any of the upper limits.

In one or more additional non-limiting illustrative embodiments, as may be combined with one or more of the preceding paragraphs, suitable anionic comfort agents include, for example, a glycosaminoglycan crosslinked with the same or different glycosaminoglycan.

Suitable crosslinking agents include bi- or polyfunctional crosslinking agents such as, for example, divinyl sulfone, diepoxides, multiepoxides, dihydrazides, dihydric alcohols, polyhydric alcohols, polyhydric thiols, anhydrides, carbodiimdes, polycarboxylic acids, carboxymethyl thiols, cysteine, and cysteine-like amino acids and the like. In one embodiment, a bi- or polyfunctional crosslinking agent is a bis- or polyepoxide, such as diglycidyl ether derivatives. According to an embodiment, the bi- or polyfunctional epoxide crosslinking agent comprises two or more glycidyl ether functional groups. The glycidyl ether functional groups react with primary hydroxyl groups of the hyaluronic acid and the chondroitin sulfate, resulting in the formation of ether bonds. In one embodiment, suitable bis- or polyfunctional crosslinking agents include, for example, 1,4-butanediol diglycidyl ether (BDDE), 1,2-bis(2,3-epoxypropoxy)ethylene (EGDGE), ethylene glycol diglycidyl ether (EGDE), 1,2-ethanediol diglycidyl ether (EDDE), diepoxyoctane, 1,6-hexanediol diglycidyl ether, polypropylene glycol diglycidyl ether, polytetramethylene glycol diglycidyl ether, neopentyl glycol diglycidyl ether, polyglycerol polyglycidyl ester, diglycerol polyglycidyl ether, glycerol polyglycidyl ether, trimethylolpropane polyglycidyl ether, pentaerythritol polyglyglycidyl ether, sorbitol polyglycidyl ether, 1,2,7,8-diepoxyoctane, 1,3-butadiene diepoxide, pentaerythritol tetraglycidyl ether, polyepoxides and the like.

Suitable dihydrazide crosslinking agents include, for example, succinic acid dihydrazide, glutaric acid dihydrazide, adipic acid dihydrazide, pimelic acid dihydrazide, suberic acid dihydrazide, azalaic acid dihydrazide, sebacic acid dihydrazide, undecanedioic acid dihydrazide, dodecanedioic acid dihydrazide, brassylic acid dihydrazide, tetradecanedioic acid dihydrazide, pentadecanedioic acid dihydrazide, thapsic acid dihydrazide, octadecanedioic acid dihydrazide and the like.

Suitable dihydric alcohol crosslinking agents include, for example, ethylene glycol, propylene glycol, butylene glycol diethylene glycol, dipropylene glycol, neopentyl glycol, 1,3-propanediol, hexylene glycol, pentylene glycol, heptylene glycol, octylene glycol and the like. Suitable polyhydric alcohol crosslinking agents include, for example glycerin, pentaerythrite, xylitol, galactitol and the like. Suitable carbodiimide crosslinking agents include, for example, a compound of formula X—N═C═N—X, wherein each X independently is a C₁ to C₆ alkyl optionally substituted with 1-2 dialkylamino groups, or is a C₅ to C₆ cycloalkyl group, such as 1-ethyl-3-(3-dimethylaminopropyl) carbodimide hydrochloride, and cyclohexyl carbodiimide. Suitable anhydride crosslinking agents include, for example, methacrylic anhydride, octeyl succinic anhydride and the like. In one embodiment, a suitable crosslinking agent is an aldehyde crosslinking agent such as, for example, formaldehyde, gluteraldehyde, and the like. In one embodiment, a suitable crosslinking agent includes, for example, an acid chloride, n-hydroxysuccinimide, polyethylene glycol diacrylates, polyethylene glycol diamines, ureas, diisocyanates and the like.

In a non-limiting illustrative embodiment, a suitable crosslinked glycosaminoglycan can be a crosslinked hyaluronic acid represented by the structure.

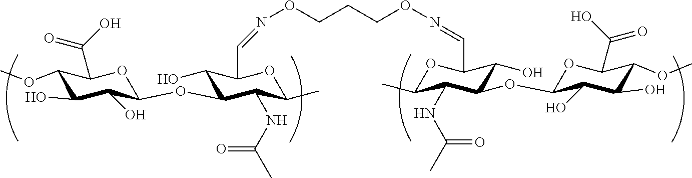

In one or more additional non-limiting illustrative embodiments, as may be combined with one or more of the preceding paragraphs, suitable anionic comfort agents include, for example, a methacrylated glycosaminoglycan such as methacrylated hyaluronic acid represented by the following structure.

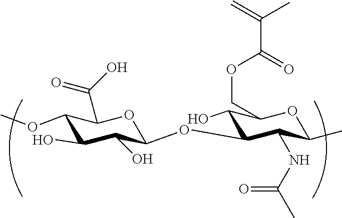

In a non-limiting illustrative embodiment, suitable anionic comfort agents include, for example, a crosslinked methacrylated glycosaminoglycan using any of the glycosaminoglycan and crosslinking agents discussed above. In some embodiments, a crosslinked methacrylated glycosaminoglycan can be a crosslinked methacrylated hyaluronic acid represented by the following structure.

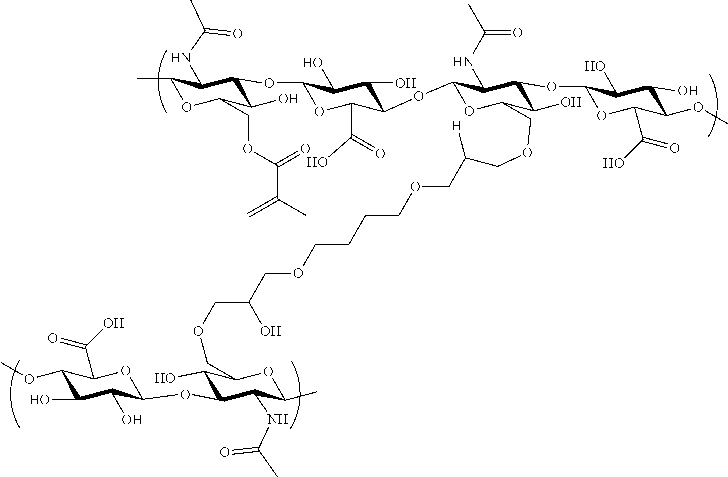

In one or more additional non-limiting illustrative embodiments, as may be combined with one or more of the preceding paragraphs, suitable anionic comfort agents include, for example, potassium salts such as potassium aspartate, and potassium pyruvate.

In one or more additional non-limiting illustrative embodiments, as may be combined with one or more of the preceding paragraphs, suitable anionic comfort agents include, for example, potassium salts such as taurine, vitamin A, Omega-3 fatty acid, alginic acid, sodium alginate, and the like and mixtures thereof.

In one or more additional non-limiting illustrative embodiments, as may be combined with one or more of the preceding paragraphs, suitable anionic comfort agents include, for example, Tremella polysaccharides such as Tremella fuciformis sporcarp.

In one or more additional non-limiting illustrative embodiments, as may be combined with one or more of the preceding paragraphs, suitable anionic comfort agents include, for example, carboxymethyl glucan.

In one or more additional non-limiting illustrative embodiments, as may be combined with one or more of the preceding paragraphs, suitable anionic comfort agents include, for example, methacrylated guar gum represented by the following structure.

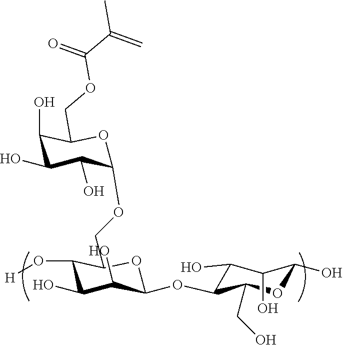

In one or more additional non-limiting illustrative embodiments, as may be combined with one or more of the preceding paragraphs, suitable anionic comfort agents include, for example, a crosslinked methacrylated guar gum where the crosslinking agents can be any of those discussed above. In an illustrative embodiment, a crosslinked methacrylated guar gum can be represented by the following structure.

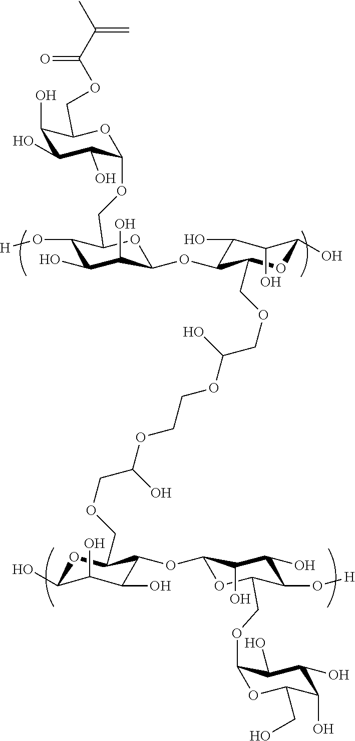

In one or more additional non-limiting illustrative embodiments, as may be combined with one or more of the preceding paragraphs, suitable anionic comfort agents include, for example, a polydimethylacrylamide (PDMA)-co-m polyethylene glycol (PEG) polymer. In an illustrative embodiment, a PDMA-co-mPEG polymer can be represented by the following structure.

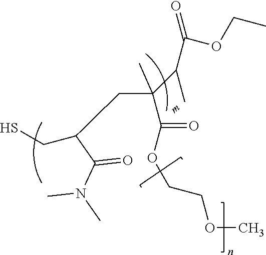

where n is from 1 to 20 and where m is from 100 to 2000.

In one or more additional non-limiting illustrative embodiments, as may be combined with one or more of the preceding paragraphs, suitable anionic comfort agents include, for example, a polyacrylic acid (PAA)-co-gPEG polymer. In an illustrative embodiment, a (PAA)-co-gPEG polymer can be represented by the following structure.

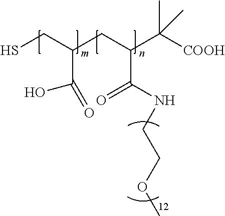

In one or more additional non-limiting illustrative embodiments, as may be combined with one or more of the preceding paragraphs, suitable anionic comfort agents include, for example, a poly(L-Lysine)-g-PEG polymer. In an illustrative embodiment, a poly(L-Lysine)-g-PEG polymer can be represented by the following structure.

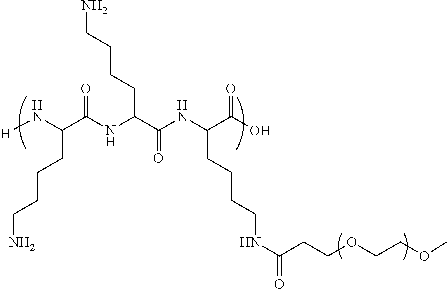

The contact lenses of the illustrative embodiments described herein will further contain one or more cationic monomers or cationic polymers to associate with the one or more anionic comfort agents. In some embodiments, the one or more cationic monomers or cationic polymers can be one or more (meth)acrylated cationic monomers or polymers or (meth)acrylamide cationic monomers or polymers. In some embodiments, suitable one or more cationic monomers or cationic polymers include, for example, cationic monomers or cationic polymers including cationic nitrogen-containing moieties such as quaternary ammonium or cationic amino moieties, or a mixture thereof. Any anionic counterions can be utilized for the cationic polymers so long as the water solubility criteria is met. Suitable counterions include halides (e.g., Cl, Br, I, or F), carboxylate, sulfate, and methylsulfate. Others can also be used, as this list is not exclusive.

In one or more additional non-limiting illustrative embodiments, as may be combined with one or more of the preceding paragraphs, cationic monomers including cationic nitrogen-containing moieties can be represented by a structure of the following formula:

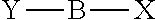

wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

In some embodiments, group X bearing a center of permanent positive charge can be of the general formula: —Z¹—N⁺(R¹)³, wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl, such as substituted or unsubstituted phenyl, or two of the R¹ groups together with the nitrogen atom to which they are attached form an aliphatic heterocyclic ring containing from 5 to 7 atoms, or the three R¹ groups together with the nitrogen atom to which they are attached form a fused ring structure containing from 5 to 7 atoms in each ring.

Representative examples of cationic monomers for use herein include methacrylamidopropyltrimethyl ammonium chloride (MAPTAC), acryloyloxyethyl trimethyl ammonium chloride (AETAC), methacryloyloxyethyl trimethyl ammonium chloride (METAC), dimethylaminopropyl methacrylate (DMAPMA), N-(2-(acryloyloxy)ethyl)-N,N-dimethyldodecan-1-aminium bromide, N-hexyl-11-(methacryloyloxy)-N,N-dimethylundecan-1-aminium bromide, N-benzyl-3-methacrylamido-N,N-dimethylpropan-1-aminium bromide, N-benzyl-12-(methacryloyloxy)-N,N-dimethyldodecan-1-aminium bromide 4-methyl-3-oxopent-4-en-1-yl (2-(trimethylammonio)ethyl) phosphate (MPC) and the like and mixtures thereof.

In one or more additional non-limiting illustrative embodiments, as may be combined with one or more of the preceding paragraphs, the one or more cationic monomers or cationic polymers to associate with the one or more anionic comfort agents can be one or more cationic-forming monomers or polymers. The term “cationic-forming monomer or polymer” as used herein shall be understood to mean that a monomer or polymer having one or more cationic-forming sites can become cationic upon exposure to pH conditions capable of transforming the cationic-forming monomer or polymer to a cationic monomer or polymer. The resulting cationic monomer or polymer can then associate with the one or more anionic comfort agents.

In one or more additional non-limiting illustrative embodiments, as may be combined with one or more of the preceding paragraphs, the one or more cationic monomers or cationic polymers can be one or more (meth)acrylated cationic-forming monomers or polymers or (meth)acrylamide cationic-forming monomers or polymers. In some embodiments, suitable one or more cationic-forming monomers or polymers include, for example, one or more acyclic tertiary amine monomers. In some embodiments, the one or more acyclic tertiary amine monomers can be understood to comprise a single acyclic tertiary amine monomer, or to comprise an acyclic tertiary amine monomer component composed of two or more acyclic tertiary amine monomers, such as two, three, or four or more.

The one or more acyclic tertiary amine monomers are monomers in which the nitrogen of the tertiary amine group is not part of a ring structure, though the monomer may contain a ring structure (e.g. N-(2-aminoethyl) aminomethyl styrene). The term “tertiary amine group” is understood to refer to a nitrogen atom directly bonded to three carbon atoms provided none of the carbon atoms is part of a carbonyl group.

Suitable one or more acyclic tertiary amine monomers include, for example, 2-(dimethylamino)ethyl acrylate, or 2-(diethylamino)ethyl acrylate, or 3-(dimethylamino)propyl acrylate, or 3-(diethylamino)propyl acrylate, or 2-(dimethylamino)ethyl methacrylate, or 2-(diethylamino)ethyl methacrylate, or 3-(dimethylamino)propyl methacrylate (DMAPMA), or 3-(diethylamino)propyl methacrylate, or N-(2-(dimethylamino)ethyl) acrylamide, or N-(2-(diethylamino)ethyl) acrylamide, or N-(3-(dimethylamino)propyl) acrylamide, or N-(3-(diethylamino)propyl) acrylamide, or N-(2-(dimethylamino)ethyl) methacrylamide, or N-(2-(diethylamino)ethyl) methacrylamide, or N-(3-(dimethylamino)propyl) methacrylamide, or N-(3-(diethylamino)propyl) methacrylamide, or 3-(diethylamino)propyl vinyl ether, or 3-(dimethylamino)propyl vinyl ether or any combinations thereof.

In one or more additional non-limiting illustrative embodiments, as may be combined with one or more of the preceding paragraphs, suitable one or more cationic-forming monomers or polymers include, for example, one or more zwitterionic polymers. In some embodiments, suitable one or more zwitterionic polymers include, for example, one or more phosphorylcholine polymers comprising a copolymer of a phosphorylcholine comonomer and a second comonomer. Suitable copolymers include, for example, a copolymer of a phosphorylcholine (meth)acrylate or (meth)acrylamide and a C₁ to C₂₅ alkyl (meth)acrylate or (meth)acrylamide. As used herein, the term “(meth)” denotes an optional methyl substituent. Thus, for example, terms such as “(meth)acrylate” denotes either methacrylate or acrylate, and “(meth)acrylamide” denotes either methacrylamide or acrylamide.

The phosphorylcholine is a zwitterionic group and includes salts (such as inner salts), and protonated and deprotonated forms thereof. In one embodiment, a phosphorylcholine-containing polymer comprises a zwitterionic group as follow:

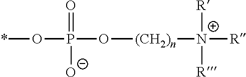

wherein * denotes the point of attachment, n is an integer of 1 to 5 and R′, R″ and R′″ independently of each other are a C₁ to C₈ alkyl group, a C₁ to C₈ hydroxyalkyl group or a hetero atom-containing group such as histidine and proline.

In some embodiments, a phosphorylcholine-containing polymer can be a poly(acryloyloxyethyl phosphorylcholine) containing polymer such as a copolymer containing 2-(acryloyloxy)ethyl-2-(trimethylammonium)ethyl phosphate (MPC) as a monomer and carboxyl-containing vinylic monomer (or amino-containing vinylic monomer). Such materials are commercially available under the tradename Lipidure® (NOF Corporation, Tokyo, Japan).

In some embodiments, the cationic nitrogen-containing moiety will be present generally as a substituent, on a part of the total monomer units of the cationic polymer. For example, the cationic polymer can comprise copolymers, terpolymers, etc., of quaternary ammonium or cationic amine-substituted monomer units and other non-cationic units referred to herein as spacer monomer units. Suitable cationic polymers include, for example, copolymers of vinyl monomers having cationic amine or quaternary ammonium functionalities with water soluble spacer monomers such as acrylamide, methacrylamide, alkyl and dialkyl acrylamides, alkyl and dialkyl methacrylamides, alkyl acrylate, and alkyl methacrylate. The alkyl and dialkyl substituted monomers can have C₁ to C₇ alkyl groups, C₁ to C₃ alkyl groups.

In some embodiments, suitable one or more zwitterionic polymers include, for example, sulfobetaine, carboxybetaine and their derivatives.

In one or more additional non-limiting illustrative embodiments, as may be combined with one or more of the preceding paragraphs, the contact lens comprising one or more anionic comfort agents associated with a cationic monomer or a cationic polymer can be prepared by first adding one or more of a cationic monomer or a cationic polymer or a cationic-forming monomer or a cationic-forming polymer to the contact lens-forming monomeric mixture. By adding the one or more of a cationic monomer or a cationic polymer or a cationic-forming monomer or a cationic-forming polymer to the contact lens-forming monomeric mixture, the one or more of a cationic monomer or a cationic polymer or a cationic-forming monomer or a cationic-forming polymer can attach, for example, by covalent bonding to the reactive functional groups of the monomers present in contact lens-forming monomeric mixture during the polymerization process as discussed above.

In some embodiments, the one or more of a cationic monomer or a cationic polymer or a cationic-forming monomer or a cationic-forming polymer are present in the contact lens-forming monomeric mixture in an amount ranging from about 0.2 wt. % to about 4 wt. %, based on the total weight of the contact lens-forming monomeric mixture. In some embodiments, the one or more of a cationic monomer or a cationic polymer or a cationic-forming monomer or a cationic-forming polymer are present in the contact lens-forming monomeric mixture in an amount ranging from about 0.5 wt. % to about 2 wt. %, based on the total weight of the contact lens-forming monomeric mixture.

Following polymerization, the resulting contact lens is thereafter soaked in a buffered solution containing at least the one or more anionic comfort agents for a time period sufficient to generate interchain non-covalent interactions with the cationic sites from the cationic monomer or cationic polymers used in making the cationic lens. In some embodiments, the one or more anionic comfort agents can be present in the buffered solution in an amount ranging from about 0.05 wt. % to about 5 wt. %, based on the total weight of the buffered solution. A suitable time period for soaking the contact lens can range from about 5 minutes to about 36 hours.

In general, the buffered solution can be any conventional buffered saline solution containing at least one or more buffer agents. Suitable one or more buffer agents include, for example, phosphate buffer agents, borate buffer agents, citrate buffer agents, and the like. A suitable phosphate buffer agent can be any known phosphate buffer agents. In one embodiment, the phosphate buffer agent comprises one or more of sodium hydrogen phosphate monobasic, sodium hydrogen phosphate dibasic, potassium hydrogen phosphate monobasic and potassium hydrogen phosphate dibasic and any suitable hydrate thereof, e.g., monohydrate and heptahydrate. A suitable borate buffer agent can be any known borate buffer agents. In one embodiment, the borate buffer agent comprises one or more of boric acid and sodium borate. A suitable citrate buffer agent can be any known citrate buffer agents. In one embodiment, the citrate buffer agent comprises one or more of citric acid and sodium citrate.

The pH of the present solutions is maintained within the range of about 4 to about 9, or from about 6 to about 8.

In some embodiments, following polymerization, the resulting contact lens is released from a mold assembly and then contacted with an aqueous packaging solution containing one or more anionic comfort agents. For example, the contact lens having the one or more of a cationic monomer or a cationic polymer or a cationic-forming monomer or a cationic-forming polymer covalently bonded therein can be transferred to an individual lens package containing a buffered saline solution containing at least the one or more anionic comfort agents disclosed herein and subjected to sterilization such as autoclaving to associate the one or more anionic comfort agents with the one or more of a cationic monomer or a cationic polymer or a cationic-forming monomer or a cationic-forming polymer which have been converted to a cationic monomer or a cationic polymer following autoclaving.

In some embodiments, the one or more anionic comfort agents are present in the aqueous packaging solution in an amount ranging from about 0.01 wt. % to about 5 wt. %, based on the total weight of the aqueous packaging solution. In some embodiments, the one or more anionic comfort agents are present in the aqueous packaging solution in an amount ranging from about 0.05 wt. % to about 2 wt. %, based on the total weight of the aqueous packaging solution.

In one or more additional non-limiting illustrative embodiments, as may be combined with one or more of the preceding paragraphs, the contact lens comprising one or more anionic comfort agents associated with a cationic monomer or a cationic polymer can be prepared by adding one or more anionic comfort agents to the contact lens-forming monomeric mixture. By adding the one or more anionic comfort agents to the contact lens-forming monomeric mixture, the anionic comfort agents can be entangled in the resulting polymerization product. In some embodiments, the one or more anionic comfort agents are present in the contact lens-forming monomeric mixture in an amount ranging from about 0.01 wt. % to about 5 wt. %, based on the total weight of the contact lens-forming monomeric mixture. In some embodiments, the one or more anionic comfort agents are present in the contact lens-forming monomeric mixture in an amount ranging from about 0.2 wt. % to about 1 wt. %, based on the total weight of the contact lens-forming monomeric mixture.

Following polymerization, the resulting contact lens is released from a mold assembly and then contacted with an aqueous packaging solution containing one or more of a cationic monomer or a cationic polymer or a cationic-forming monomer or a cationic-forming polymer. For example, the contact lens having the one or more anionic comfort agents entangled therein can be transferred to an individual lens package containing a buffered saline solution containing at least the one or more of a cationic monomer or a cationic polymer or a cationic-forming monomer or a cationic-forming polymers disclosed herein and subjected to sterilization such as autoclaving to associate the one or more anionic comfort agents with the one or more of a cationic monomer or a cationic polymer or a cationic-forming monomer or a cationic-forming polymer which have been converted to a cationic monomer or a cationic polymer following autoclaving.

In some embodiments, the one or more of a cationic monomer or a cationic polymer or a cationic-forming monomer or a cationic-forming polymer are present in the aqueous packaging solution in an amount ranging from about 0.1 wt. % to about 5 wt. %, based on the total weight of the aqueous packaging solution. In some embodiments, the one or more of a cationic monomer or a cationic polymer or a cationic-forming monomer or a cationic-forming polymer are present in the aqueous packaging solution in an amount ranging from about 0.2 wt. % to about 2 wt. %, based on the total weight of the aqueous packaging solution.

Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, steam sterilizing or autoclaving of the sealed container at temperatures of about 120° C. or higher.

The aqueous packaging solutions of the illustrative embodiments are physiologically compatible. Specifically, the solution must be “ophthalmically safe” for use with a lens such as a contact lens, meaning that a contact lens treated with the solution is generally suitable and safe for direct placement on the eye without rinsing, that is, the solution is safe and comfortable for daily contact with the eye via a contact lens that has been wetted with the solution. An ophthalmically safe solution has a tonicity and pH that is compatible with the eye and includes materials, and amounts thereof, that are non-cytotoxic according to ISO standards and U.S. Food & Drug Administration (FDA) regulations.

The aqueous packaging solution should also be sterile in that the absence of microbial contaminants in the product prior to release must be statistically demonstrated to the degree necessary for such products. The liquid media useful in the present invention are selected to have no substantial detrimental effect on the lens being treated or cared for and to allow or even facilitate the present lens treatment or treatments. The liquid media are preferably aqueous-based. A particularly useful aqueous liquid medium is that derived from saline, for example, a conventional saline solution or a conventional buffered saline solution.

The pH of the present solutions is maintained within the range of about 6 to about 9, or about 6.5 to about 7.8. As mentioned above, additional buffer may optionally be added, such as boric acid, sodium borate, potassium citrate, sodium citrate, citric acid, sodium bicarbonate, various mixed phosphate buffers (including combinations of Na₂HPO₄, NaH₂PO₄ and KH₂PO₄), hydrates thereof and the like and mixtures thereof. Generally, buffers will be used in amounts ranging from about 0.05 to about 2.5 percent by weight, and preferably from about 0.1 to about 1.5 percent by weight of the solution. However, according to certain embodiments, tris(hydroxymethyl)aminomethane, or salts thereof, function as the sole buffer.

In one embodiment, the aqueous packaging solution can further comprise one or more buffer agents. Suitable one or more buffer agents include, for example, phosphate buffer agents, borate buffer agents, citrate buffer agents, and the like. A suitable phosphate buffer agent can be any known phosphate buffer agents. In one embodiment, the phosphate buffer agent comprises one or more of sodium hydrogen phosphate monobasic, sodium hydrogen phosphate dibasic, potassium hydrogen phosphate monobasic and potassium hydrogen phosphate dibasic and any suitable hydrate thereof, e.g., monohydrate and heptahydrate. A suitable borate buffer agent can be any known borate buffer agents. In one embodiment, the borate buffer agent comprises one or more of boric acid and sodium borate. A suitable citrate buffer agent can be any known citrate buffer agents. In one embodiment, the citrate buffer agent comprises one or more of citric acid and sodium citrate.

In one embodiment, the one or more buffer agents are present in the aqueous packaging solution in an amount ranging from about 0.001 wt. % to about 2 wt. %, based on the total weight of the aqueous packaging solution. In one embodiment, the phosphate buffer agent is present in the aqueous packaging solution in an amount ranging from about 0.001 wt. % to about 1 wt. %, based on the total weight of the aqueous packaging solution.

Typically, the aqueous packaging solutions are also adjusted with tonicity agents, to approximate the osmotic pressure of normal lacrimal fluids which is equivalent to a 0.9 percent solution of sodium chloride or 2.5 percent of glycerol solution. The solutions are made substantially isotonic with physiological saline used alone or in combination, otherwise if simply blended with sterile water and made hypotonic or made hypertonic the lenses will lose their desirable optical parameters. Correspondingly, excess saline may result in the formation of a hypertonic solution which will cause stinging and eye irritation.

Examples of suitable tonicity adjusting agents include, but are not limited to, sodium and potassium chloride, dextrose, glycerin, calcium and magnesium chloride and the like and mixtures thereof. These agents are typically used individually in amounts ranging from about 0.01 to about 2.5% w/v and preferably from about 0.2 to about 1.5% w/v. Preferably, the tonicity agent will be employed in an amount to provide a final osmotic value of at least about 200 mOsm/kg, or from about 200 to about 400 mOsm/kg, or from about 250 to about 350 mOsm/kg, or from about 280 to about 320 mOsm/kg.

If desired, one or more additional components can be included in the aqueous packaging solution. Such an additional component or components are chosen to impart or provide at least one beneficial or desired property to the aqueous packaging solution. Such additional components may be selected from components which are conventionally used in one or more ophthalmic device care compositions. Examples of such additional components include cleaning agents, wetting agents, nutrient agents, sequestering agents, viscosity builders, contact lens conditioning agents, antioxidants, and the like and mixtures thereof. These additional components may each be included in the aqueous packaging solutions in an amount effective to impart or provide the beneficial or desired property to the aqueous packaging solutions. For example, such additional components may be included in the aqueous packaging solutions in amounts similar to the amounts of such components used in other, e.g., conventional, contact lens care products.

Useful sequestering agents include, but are not limited to, disodium ethylene diamine tetraacetate, alkali metal hexametaphosphate, citric acid, sodium citrate and the like and mixtures thereof.

Useful viscosity builders include, but are not limited to, hydroxyethyl cellulose, hydroxymethyl cellulose, polyvinyl pyrrolidone, polyvinyl alcohol and the like and mixtures thereof.

Useful antioxidants include, but are not limited to, sodium metabisulfite, sodium thiosulfate, N-acetylcysteine, butylated hydroxyanisole, butylated hydroxytoluene and the like and mixtures thereof.

The following examples are provided to enable one skilled in the art to practice the invention and are merely illustrative of the invention. The examples should not be read as limiting the scope of the invention as defined in the claims.

In the examples, the following abbreviations are used.
HEMA: 2-hydroxyethylmethacrylate.
EGDMA: Ethylene glycol dimethacrylate.
NVP: N-vinyl-2-pyrrolidone.
HA: Hyaluronic acid.
FITC-tagged hyaluronic acid: a hyaluronic acid polymer represented by the following structure.

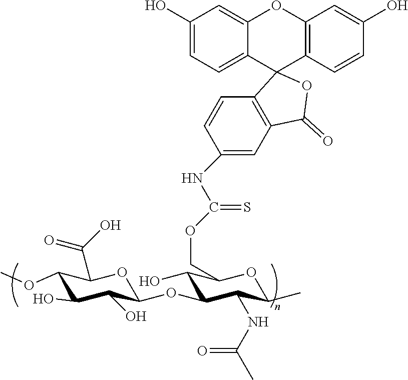

PAA: Polyacrylic acid having a weight average molecular weight of 5000 DA.
Quat 1: N-hexyl-11-(methacryloyloxy)-N,N-dimethylundecan-1-aminium bromide represented by the following structure.

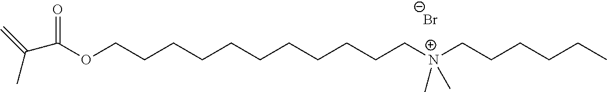 [SMILES: C=C(C)C(=O)OCCCCCCCCCCC[N+](C)(C)CCCCCC ; [Br-]]

Quat 2: N-benzyl-3-methacrylamido-N,N-dimethylpropan-1-aminium bromide represented by the following structure.

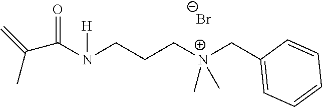 [SMILES: C=C(C)C(=O)NCCC[N+](C)(C)Cc1ccccc1 ; [Br-]]

Quat 3: N-(2-(acryloyloxy)ethyl)-N,N-dimethyldodecan-1-aminium bromide represented by the following structure.

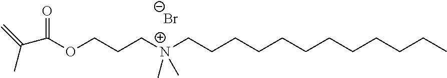 [SMILES: C=C(C)C(=O)OCCC[N+](C)(C)CCCCCCCCCCCC ; [Br-]]

Quat 4: N-benzyl-12-(methacryloyloxy)-N,N-dimethyldodecan-1-aminium bromide represented by the following structure.

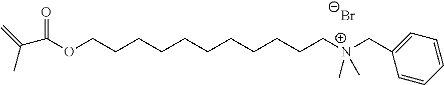 [SMILES: C=C(C)C(=O)OCCCCCCCCCCC[N+](C)(C)Cc1ccccc1 ; [Br-]]

Quat 5: dimethylaminopropyl methacrylate represented by the following structure.

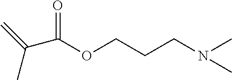

Various polymerization products were formed as discussed below and characterized by standard testing procedures such as:

Modulus (g/mm²) and % elongation were measured per ASTM 1708 employing an Instron (Model 4502) instrument where the film sample was immersed in borate buffered saline; an appropriate size of the film sample was gauge length 22 mm and width 4.75 mm, where the sample further has ends forming a dogbone shape to accommodate gripping of the sample with clamps of the Instron instrument, and a thickness of 100±50 microns.

Tensile strength (g/mm²) was measured according to ASTM D-1708a.

Tear strength was measured according to ASTM D-1938 under the same physical conditions as for tensile modulus.

Oxygen permeability (also referred to as Dk) is determined by the following procedure. Other methods and/or instruments may be used as long as the oxygen permeability values obtained therefrom are equivalent to the described method. The oxygen permeability of silicone hydrogels is measured by the polarographic method (ANSI Z80.20-1998) using an 02 Permeometer Model 201T instrument (Createch, Albany, Calif. USA) having a probe comprising a central, circular gold cathode at its end and a silver anode insulated from the cathode. Measurements are taken only on pre-inspected pinhole-free, flat silicone hydrogel film samples of three different center thicknesses ranging from 150 to 600 microns. Center thickness measurements of the film samples may be measured using a Rehder ET-1 electronic thickness gauge. Generally, the film samples have the shape of a circular disk. Measurements are taken with the film sample and probe immersed in a bath comprising circulating phosphate buffered saline (PBS) equilibrated at 35° C.+/−0.2°. Prior to immersing the probe and film sample in the PBS bath, the film sample is placed and centered on the cathode premoistened with the equilibrated PBS, ensuring no air bubbles or excess PBS exists between the cathode and the film sample, and the film sample is then secured to the probe with a mounting cap, with the cathode portion of the probe contacting only the film sample. For silicone hydrogel films, it is frequently useful to employ a Teflon polymer membrane, e.g., having a circular disk shape, between the probe cathode and the film sample. In such cases, the Teflon membrane is first placed on the pre-moistened cathode, and then the film sample is placed on the Teflon membrane, ensuring no air bubbles or excess PBS exists beneath the Teflon membrane or film sample. Once measurements are collected, only data with a correlation coefficient value (R²) of 0.97 or higher should be entered into the calculation of Dk value. At least two Dk measurements per thickness, and meeting R² value, are obtained.

Using known regression analyses, oxygen permeability (Dk) is calculated from the film samples having at least three different thicknesses. Any film samples hydrated with solutions other than PBS are first soaked in purified water and allowed to equilibrate for at least 24 hours, and then soaked in PHB and allowed to equilibrate for at least 12 hours. The instruments are regularly cleaned and regularly calibrated using RGP standards. Upper and lower limits are established by calculating a +/−8.8% of the Repository values established by William J. Benjamin, et al., The Oxygen Permeability of Reference Materials, Optom Vis Sci 7 (12s): 95 (1997), the disclosure of which is incorporated herein in its entirety.

Water %: Two sets of six hydrated lenses or films are blotted dry on a piece of filter paper to remove excess water, and samples are weighed (wet weight). Samples are then placed in a microwave oven for 10 minutes inside a jar containing desiccant. The samples are then allowed to sit for 30 minutes to equilibrate to room temperature and reweighed (dry weight). The percent water is calculated from the wet and dry weights.

Contact Angle (CBCA): Captive bubble contact angle data was collected on a First Ten Angstroms FTA-1000 prop Shape Instrument. All samples were rinsed in HPLC grade water prior to analysis in order to remove components of the packaging solution from the sample surface. Prior to data collection the surface tension of the water used for all experiments was measured using the pendant drop method. In order for the water to qualify as appropriate for use, a surface tension value of 70-72 dynes/cm was expected. All lens samples were placed onto a curved sample holder and submerged into a quartz cell filled with HPLC grade water. Advancing and receding captive bubble contact angles were collected for each sample. The advancing contact angle is defined as the angle measured in water as the air bubble is retracting from the lens surface (water is advancing across the surface). All captive bubble data was collected using a high-speed digital camera focused onto the sample/air bubble interface. The contact angle was calculated at the digital frame just prior to contact line movement across the sample/air bubble interface. The receding contact angle is defined as the angle measured in water as the air bubble is expanding across the sample surface (water is receding from the surface).

### Example 1

### Preparation of a Hydrogel Contact Lens.

A master batch of a monomeric mixture was prepared by mixing 75 g of NVP, 17 g of glycerol, 2 g of HEMA, 5 g of Pluronic 407 dimethacrylate, 1 g of EGDMA, 2 g of a UV blocker and 0.5 g of a thermal initiator. This master batch was used to thermally cast the contact lens that was used as control.

### Example 2

### Preparation of HA Containing Hydrogel Contact Lens.

10 Grams of the monomeric mixture prepared in Example 1 was mixed with a 90% aqueous solution of 0.5 g HA. The contact lenses were thermally cast to provide HA containing contact lens.

### Example 3

### Preparation of FITC-Tagged HA.

Hyaluronic acid (weight average molecular weight 1,000,000 Da) 3 g was dissolved in dimethylsulfoxide (70 mL). To this reaction mixture dimethyltinlaurate (1 mL) was added followed by addition of pyridine (10 mL). The reaction mixture was stirred at 25° C. for 30 minutes and then 1 g of 3′,6′-dihydroxy-5-isothiocyanato-3H-spiro[isobenzofuran-1,9′-xanthen]-3-one (also known as fluorescein isothiocyanate (FITC)) was added followed by additional 20 mL dimethylsulfoxide. The reaction mixture was stirred for 24 hours at 25° C. and then dialyzed by cutting 1000 dalton molecular weight for 3 days. The dialyzed portion was lyophilized to give fluffy yellow product and characterized as FITC tagged HA (also known as (2S,3S,4R,5R,6R)-6-(((2S,3S,4R,5S,6R)-3-acetamido-6-((((3′,6′-dihydroxy-3-oxo-3H-spiro[isobenzofuran-1,9′-xanthen]-5-yl) carbamothioyl)oxy)methyl)-5-hydroxy-2-methyltetrahydro-2H-pyran-4-yl)oxy)-4,5-dihydroxy-3-methoxytetrahydro-2H-pyran-2-carboxylic acid).

The synthesis of FITC-tagged HA is set forth below.

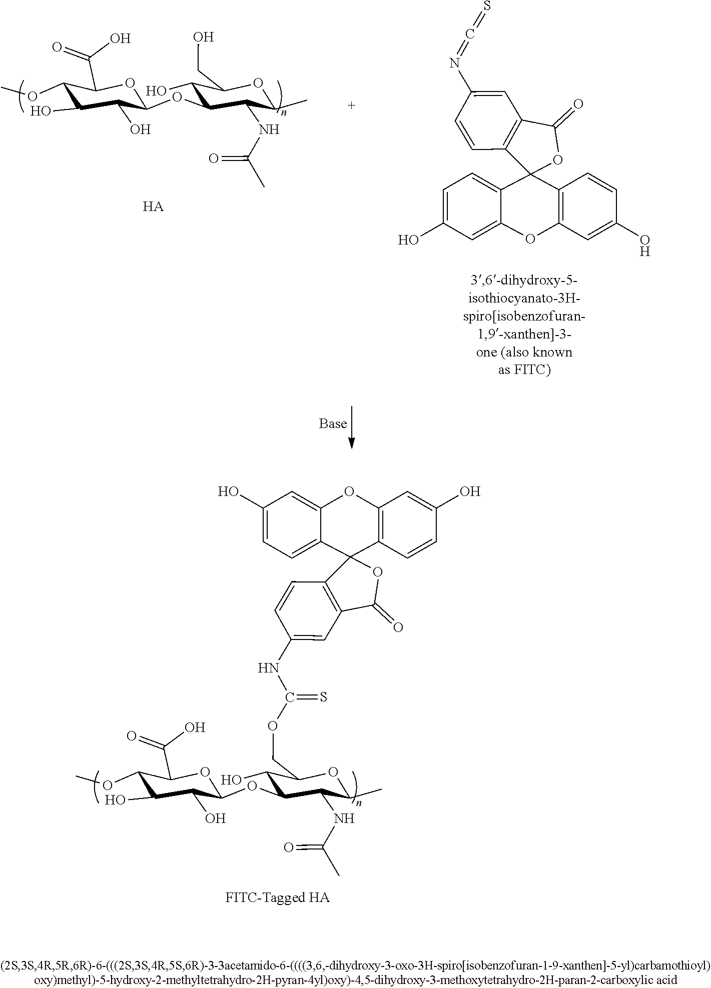

### Example 4

### Preparation of FITC Tagged HA Containing Contact Lenses.

10 Grams of the monomeric mixture prepared in Example 1 was mixed with 0.5 g of FITC-tagged hyaluronic acid of Example 3. The contact lenses were thermally cast to provide FITC-tagged HA containing contact lens.

### Example 5

### Preparation of PAA Containing Hydrogel Contact Lens.

10 Grams of the monomeric mixture prepared in Example 1 was mixed with 1 g of PAA (weight average molecular weight 5000 Dalton). The contact lenses were thermally cast to provide PAA containing contact lens.

### Example 6

### Preparation of Hydrogel Contact Lens Containing Cationic Moieties.

Cationic hydrogel contact lenses were prepared by thermally curing after mixing with different cationic monomers, a monomer capable of forming a cation at acidic pH or zwitterionic monomers (i.e., Quat monomer) with the monomeric mixture of Example 1 as set forth below in Tables 1 and 2. The lenses were then evaluated for

TABLE 1

| | | Tensile | | | Tear | | | | |
|---|---|---|---|---|---|---|---|---|---|
| | Modulus | Strength | | | Strength | | | % Water | |
| Quat Monomer | (g/mm²) | (g/mm²) | % Elongation | | (g/mm) | | Dk | Content | CA |
| 2% Quat 1 | 41 (5) | 42 (17) | 101 | (39) | 2.7 | (0.2) | 42.8 | 78.3 (0.5) | 81 |
| 2% Quat 2 | 34 (1) | 55 (14) | 142 | (21) | 2.7 | (0.2) | 42.1 | 79.0 (0.7) | 78 |
| 2% Quat 3 | 36 (2) | 29 (7) | 155 | (14) | 2.8 | (0.2) | 44.7 | 78.2 (0.1) | 75 |
| 2% Quat 4 | 39 (3) | 67 (12) | 152 | (24) | 2.3 | (0.2) | 44.8 | 77.4 (0.2) | 75 |
| 1% Quat 1 | 52 (4) | 34 (25) | 58 | (36) | 3 | (0.2) | 44.1 | 77.5 (0.1) | 69 |
| 1% Quat 2 | 44 (3) | 32 (18) | 68 | (34) | 3 | (0.3) | 44 | 78.1 (0.2) | 73 |
| 1% Quat 3 | 47 (2) | 25 (12) | 52 | (21) | 3 | (0.7) | 50.8 | 77.8 (0.1) | 42 |
| 1% Quat 4 | 48 (2) | 31 (18) | 68 | (47) | 3 | (0.7) | 50.9 | 77.6 (0.4) | 61 |
| Control | 52 (2) | 89 (43) | 133 | (56) | 4 | (0.6) | 46.8 | 78.0 (0.1) | 61 |
| No quat | | | | | | | | | |

TABLE 2

| | | Tensile | | | Tear | | | |
|---|---|---|---|---|---|---|---|---|
| | Modulus | Strength | | % | Strength | | | % Water |
| Quat 5 | (g/mm²) | (g/mm²) | | Elongation | (g/mm) | Dk | CA | Content |
| 0% | 48 (7) | 36 | (5) | 74 (17) | 2 (0.6) | 46.5 | 68 | 78.4 |
| 0.5% | 45 (3) | 42 | (18) | 92 (38) | 3 (0.6) | 48.3 | 67 | 78.5 |
| 1% | 41 (2) | 21 | (6) | 54 (15) | 3 (1) | 53.7 | 74 | 79.2 |
| 2% | 30 (4) | 13 | (9) | 45 (26) | 2 (0.5) | 47.6 | 84 | 80.0 |
| 4% | 23 (2) | 8 | (2) | 38 (6) | 2 (0.4) | 46.6 | 87 | 82.2 |

According to an aspect of the present disclosure, a contact lens comprises one or more anionic comfort agents associated with a cationic monomer or a cationic polymer.

In non-limiting illustrative embodiments, as may be combined with one or more of the preceding paragraphs, the one or more anionic comfort agents comprise a polymer containing carboxylic acid functionality.

In non-limiting illustrative embodiments, as may be combined with one or more of the preceding paragraphs, the polymer containing carboxylic acid functionality comprises a polymer containing poly(acrylic acid).

In non-limiting illustrative embodiments, as may be combined with one or more of the preceding paragraphs, the polymer containing poly(acrylic acid) has a weight average molecular weight ranging from about 1,000 to about 50,000 Da.

In non-limiting illustrative embodiments, as may be combined with one or more of the preceding paragraphs, the one or more anionic comfort agents comprise one or more glycosaminoglycans.

In non-limiting illustrative embodiments, as may be combined with one or more of the preceding paragraphs, the one or more glycosaminoglycans are selected from the group consisting of chondroitin, chondroitin sulfate, dermatan, dermatan sulfate, heparin, heparan sulfate, hyaluronan and hyaluronic acid or a salt thereof.

In non-limiting illustrative embodiments, as may be combined with one or more of the preceding paragraphs, the one or more anionic comfort agents are associated with the cationic monomer.

In non-limiting illustrative embodiments, as may be combined with one or more of the preceding paragraphs, the cationic monomer is a (meth)acrylated cationic monomer or a (meth)acrylamide cationic monomer.

In non-limiting illustrative embodiments, as may be combined with one or more of the preceding paragraphs, the cationic monomer comprises a cationic nitrogen-containing moiety.

In non-limiting illustrative embodiments, as may be combined with one or more of the preceding paragraphs, the cationic monomer is represented by a structure of the following formula:

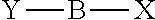

wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

In non-limiting illustrative embodiments, as may be combined with one or more of the preceding paragraphs, X is a group of the general formula:

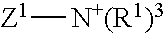

wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl.

In non-limiting illustrative embodiments, as may be combined with one or more of the preceding paragraphs, the cationic monomer is selected from the group consisting of methacrylamidopropyltrimethyl ammonium chloride (MAPTAC), acryloyloxyethyl trimethyl ammonium chloride (AETAC), methacryloyloxyethyl trimethyl ammonium chloride (METAC), dimethylaminopropyl methacrylate (DMAPMA), N-(2-(acryloyloxy)ethyl)-N,N-dimethyldodecan-1-aminium bromide, N-hexyl-11-(methacryloyloxy)-N,N-dimethylundecan-1-aminium bromide, N-benzyl-3-methacrylamido-N,N-dimethylpropan-1-aminium bromide, N-benzyl-12-(methacryloyloxy)-N,N-dimethyldodecan-1-aminium bromide 4-methyl-3-oxopent-4-en-1-yl (2-(trimethylammonio)ethyl) phosphate (MPC) and mixtures thereof.

In non-limiting illustrative embodiments, as may be combined with one or more of the preceding paragraphs, the cationic monomer or the cationic polymer is derived from a cationic-forming monomer or a cationic-forming polymer.

In non-limiting illustrative embodiments, as may be combined with one or more of the preceding paragraphs, the cationic-forming monomer or the cationic-forming polymer is a (meth)acrylated cationic-forming monomer, a (meth)acrylated cationic-forming polymer, (meth)acrylamide cationic-forming monomer or a (meth)acrylamide cationic-forming polymer.

In non-limiting illustrative embodiments, as may be combined with one or more of the preceding paragraphs, the cationic-forming monomer is an acyclic tertiary amine monomer.

In non-limiting illustrative embodiments, as may be combined with one or more of the preceding paragraphs, the acyclic tertiary amine monomer is a (meth)acrylated acyclic tertiary amine monomer.

In non-limiting illustrative embodiments, as may be combined with one or more of the preceding paragraphs, the (meth)acrylated acyclic tertiary amine monomer is selected from the group consisting of 2-(dimethylamino)ethyl acrylate, or 2-(diethylamino)ethyl acrylate, or 3-(dimethylamino)propyl acrylate, or 3-(diethylamino)propyl acrylate, or 2-(dimethylamino)ethyl methacrylate, or 2-(diethylamino)ethyl methacrylate, or 3-(dimethylamino)propyl methacrylate (DMAPMA), or 3-(diethylamino)propyl methacrylate, or N-(2-(dimethylamino)ethyl) acrylamide, or N-(2-(diethylamino)ethyl) acrylamide, or N-(3-(dimethylamino)propyl) acrylamide, or N-(3-(diethylamino)propyl) acrylamide, or N-(2-(dimethylamino)ethyl) methacrylamide, or N-(2-(diethylamino)ethyl) methacrylamide, or N-(3-(dimethylamino)propyl) methacrylamide, or N-(3-(diethylamino)propyl) methacrylamide, or 3-(diethylamino)propyl vinyl ether, or 3-(dimethylamino)propyl vinyl ether and combinations thereof.

In non-limiting illustrative embodiments, as may be combined with one or more of the preceding paragraphs, the cationic-forming polymer is a zwitterionic polymer.

In non-limiting illustrative embodiments, as may be combined with one or more of the preceding paragraphs, the zwitterionic polymer is a phosphorylcholine polymer comprising a copolymer of a phosphorylcholine comonomer and a second comonomer.

In non-limiting illustrative embodiments, as may be combined with one or more of the preceding paragraphs, the phosphorylcholine polymer comprises a copolymer of a phosphorylcholine (meth)acrylate or (meth)acrylamide and a C₁ to C₂₅ alkyl (meth)acrylate or (meth)acrylamide.

In non-limiting illustrative embodiments, as may be combined with one or more of the preceding paragraphs, the one or more anionic comfort agents are released over a period of from about 5 minutes to about 40 hours.

According to another aspect of the present disclosure, a method for making a contact lens comprising one or more anionic comfort agents associated with a cationic monomer or a cationic polymer comprises:
(a) providing a contact lens-forming monomeric mixture comprising (i) one or more contact lens-forming monomers, and (ii) one or more anioinic comfort agents,
(b) subjecting the contact lens-forming monomeric mixture to polymerization conditions to provide a polymerized contact lens having the one or more anioinic comfort agents entangled in the polymerized contact lens, and
(c) soaking the polymerized contact lens in a buffered solution comprising one of a cationic monomer, a cationic polymer, a cationic-forming monomer or a cationic-forming polymer.

In non-limiting illustrative embodiments, as may be combined with one or more of the preceding paragraphs, the one or more anionic comfort agents comprise a polymer containing carboxylic acid functionality.

In non-limiting illustrative embodiments, as may be combined with one or more of the preceding paragraphs, the polymer containing carboxylic acid functionality comprises a polymer containing poly(acrylic acid).

In non-limiting illustrative embodiments, as may be combined with one or more of the preceding paragraphs, the one or more anionic comfort agents comprise one or more glycosaminoglycans.

In non-limiting illustrative embodiments, as may be combined with one or more of the preceding paragraphs, the one or more glycosaminoglycans are selected from the group consisting of chondroitin, chondroitin sulfate, dermatan, dermatan sulfate, heparin, heparan sulfate, hyaluronan and hyaluronic acid or a salt thereof.

In non-limiting illustrative embodiments, as may be combined with one or more of the preceding paragraphs, the one or more anionic comfort agents are associated with the cationic monomer.

In non-limiting illustrative embodiments, as may be combined with one or more of the preceding paragraphs, the cationic monomer is a (meth)acrylated cationic monomer or a (meth)acrylamide cationic monomer.

In non-limiting illustrative embodiments, as may be combined with one or more of the preceding paragraphs, the cationic monomer comprises a cationic nitrogen-containing moiety.

In non-limiting illustrative embodiments, as may be combined with one or more of the preceding paragraphs, the cationic monomer is represented by a structure of the following formula:

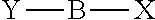

wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

In non-limiting illustrative embodiments, as may be combined with one or more of the preceding paragraphs, X is a group of the general formula:

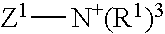

wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl, such as substituted or unsubstituted phenyl, or two of the R¹ groups together with the nitrogen atom to which they are attached form an aliphatic heterocyclic ring containing from 5 to 7 atoms, or the three R¹ groups together with the nitrogen atom to which they are attached form a fused ring structure containing from 5 to 7 atoms in each ring.

In non-limiting illustrative embodiments, as may be combined with one or more of the preceding paragraphs, the cationic monomer is selected from the group consisting of methacrylamidopropyltrimethyl ammonium chloride (MAPTAC), acryloyloxyethyl trimethyl ammonium chloride (AETAC), methacryloyloxyethyl trimethyl ammonium chloride (METAC), dimethylaminopropyl methacrylate (DMAPMA), N-(2-(acryloyloxy)ethyl)-N,N-dimethyldodecan-1-aminium bromide, N-hexyl-11-(methacryloyloxy)-N,N-dimethylundecan-1-aminium bromide, N-benzyl-3-methacrylamido-N,N-dimethylpropan-1-aminium bromide, N-benzyl-12-(methacryloyloxy)-N,N-dimethyldodecan-1-aminium bromide 4-methyl-3-oxopent-4-en-1-yl (2-(trimethylammonio)ethyl) phosphate (MPC) and mixtures thereof.

In non-limiting illustrative embodiments, as may be combined with one or more of the preceding paragraphs, the cationic monomer or the cationic polymer is derived from a cationic-forming monomer or a cationic-forming polymer.

In non-limiting illustrative embodiments, as may be combined with one or more of the preceding paragraphs, the cationic-forming monomer or the cationic-forming polymer is a (meth)acrylated cationic-forming monomer, a (meth)acrylated cationic-forming polymer, (meth)acrylamide cationic-forming monomer or a (meth)acrylamide cationic-forming polymer.

In non-limiting illustrative embodiments, as may be combined with one or more of the preceding paragraphs, the cationic-forming monomer is a (meth)acrylated acyclic tertiary amine monomer.

In non-limiting illustrative embodiments, as may be combined with one or more of the preceding paragraphs, the (meth)acrylated acyclic tertiary amine monomer is selected from the group consisting of 2-(dimethylamino)ethyl acrylate, 2-(diethylamino)ethyl acrylate, 3-(dimethylamino)propyl acrylate, 3-(diethylamino)propyl acrylate, 2-(dimethylamino)ethyl methacrylate, 2-(diethylamino)ethyl methacrylate, 3-(dimethylamino)propyl methacrylate (DMAPMA), 3-(diethylamino)propyl methacrylate, N-(2-(dimethylamino)ethyl) acrylamide, N-(2-(diethylamino)ethyl) acrylamide, N-(3-(dimethylamino)propyl) acrylamide, N-(3-(diethylamino)propyl) acrylamide, N-(2-(dimethylamino)ethyl) methacrylamide, N-(2-(diethylamino)ethyl) methacrylamide, N-(3-(dimethylamino)propyl) methacrylamide, N-(3-(diethylamino)propyl) methacrylamide, 3-(diethylamino)propyl vinyl ether, 3-(dimethylamino)propyl vinyl ether and combinations thereof.

In non-limiting illustrative embodiments, as may be combined with one or more of the preceding paragraphs, the cationic-forming polymer is a zwitterionic polymer.

In non-limiting illustrative embodiments, as may be combined with one or more of the preceding paragraphs, the zwitterionic polymer is a phosphorylcholine polymer comprising a copolymer of a phosphorylcholine comonomer and a second comonomer.

In non-limiting illustrative embodiments, as may be combined with one or more of the preceding paragraphs, the phosphorylcholine polymer comprises a copolymer of a phosphorylcholine (meth)acrylate or (meth)acrylamide and a C₁ to C₂₅ alkyl (meth)acrylate or (meth)acrylamide.

In non-limiting illustrative embodiments, as may be combined with one or more of the preceding paragraphs, the buffered solution comprises from about 0.2 wt. % to about 4 wt. %, based on the total weight of the buffered solution, of the one of a cationic monomer, a cationic polymer, a cationic-forming monomer or a cationic-forming polymer.

In non-limiting illustrative embodiments, as may be combined with one or more of the preceding paragraphs, the buffered solution has a pH of about 6 to about 8.

According to yet another aspect of the present disclosure, a method for making a contact lens comprising one or more anionic comfort agents associated with a cationic monomer or a cationic polymer comprises:
(a) providing a contact lens-forming monomeric mixture comprising (i) one or more contact lens-forming monomers, and (ii) one of a cationic monomer, a cationic polymer, a cationic-forming monomer or a cationic-forming polymer,
(b) subjecting the contact lens-forming monomeric mixture to polymerization conditions to provide a polymerized contact lens, and
(c) soaking the polymerized contact lens in a buffered solution comprising one or more anioinic comfort agents.

In non-limiting illustrative embodiments, as may be combined with one or more of the preceding paragraphs, the one or more anionic comfort agents comprise a polymer containing carboxylic acid functionality.

In non-limiting illustrative embodiments, as may be combined with one or more of the preceding paragraphs, the polymer containing carboxylic acid functionality comprises a polymer containing poly(acrylic acid).

In non-limiting illustrative embodiments, as may be combined with one or more of the preceding paragraphs, the one or more anionic comfort agents comprise one or more glycosaminoglycans.

In non-limiting illustrative embodiments, as may be combined with one or more of the preceding paragraphs, the one or more glycosaminoglycans are selected from the group consisting of chondroitin, chondroitin sulfate, dermatan, dermatan sulfate, heparin, heparan sulfate, hyaluronan and hyaluronic acid or a salt thereof.

In non-limiting illustrative embodiments, as may be combined with one or more of the preceding paragraphs, the one or more anionic comfort agents are associated with the cationic monomer.

In non-limiting illustrative embodiments, as may be combined with one or more of the preceding paragraphs, the cationic monomer is a (meth)acrylated cationic monomer or a (meth)acrylamide cationic monomer.

In non-limiting illustrative embodiments, as may be combined with one or more of the preceding paragraphs, the cationic monomer comprises a cationic nitrogen-containing moiety.

In non-limiting illustrative embodiments, as may be combined with one or more of the preceding paragraphs, the cationic monomer is represented by a structure of the following formula:

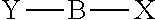

wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

In non-limiting illustrative embodiments, as may be combined with one or more of the preceding paragraphs, X is a group of the general formula:

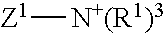

wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl, such as substituted or unsubstituted phenyl, or two of the R¹ groups together with the nitrogen atom to which they are attached form an aliphatic heterocyclic ring containing from 5 to 7 atoms, or the three R¹ groups together with the nitrogen atom to which they are attached form a fused ring structure containing from 5 to 7 atoms in each ring.

In non-limiting illustrative embodiments, as may be combined with one or more of the preceding paragraphs, the cationic monomer is selected from the group consisting of methacrylamidopropyltrimethyl ammonium chloride (MAPTAC), acryloyloxyethyl trimethyl ammonium chloride (AETAC), methacryloyloxyethyl trimethyl ammonium chloride (METAC), dimethylaminopropyl methacrylate (DMAPMA), N-(2-(acryloyloxy)ethyl)-N,N-dimethyldodecan-1-aminium bromide, N-hexyl-11-(methacryloyloxy)-N,N-dimethylundecan-1-aminium bromide, N-benzyl-3-methacrylamido-N,N-dimethylpropan-1-aminium bromide, N-benzyl-12-(methacryloyloxy)-N,N-dimethyldodecan-1-aminium bromide 4-methyl-3-oxopent-4-en-1-yl (2-(trimethylammonio)ethyl) phosphate (MPC) and mixtures thereof.

In non-limiting illustrative embodiments, as may be combined with one or more of the preceding paragraphs, the cationic monomer or the cationic polymer is derived from a cationic-forming monomer or a cationic-forming polymer.

In non-limiting illustrative embodiments, as may be combined with one or more of the preceding paragraphs, the cationic-forming monomer or the cationic-forming polymer is a (meth)acrylated cationic-forming monomer, a (meth)acrylated cationic-forming polymer, (meth)acrylamide cationic-forming monomer or a (meth)acrylamide cationic-forming polymer.

In non-limiting illustrative embodiments, as may be combined with one or more of the preceding paragraphs, the cationic-forming monomer is a (meth)acrylated acyclic tertiary amine monomer.

In non-limiting illustrative embodiments, as may be combined with one or more of the preceding paragraphs, the (meth)acrylated acyclic tertiary amine monomer is selected from the group consisting of 2-(dimethylamino)ethyl acrylate, 2-(diethylamino)ethyl acrylate, 3-(dimethylamino)propyl acrylate, 3-(diethylamino)propyl acrylate, 2-(dimethylamino)ethyl methacrylate, 2-(diethylamino)ethyl methacrylate, 3-(dimethylamino)propyl methacrylate (DMAPMA), 3-(diethylamino)propyl methacrylate, N-(2-(dimethylamino)ethyl) acrylamide, N-(2-(diethylamino)ethyl) acrylamide, N-(3-(dimethylamino)propyl) acrylamide, N-(3-(diethylamino)propyl) acrylamide, N-(2-(dimethylamino)ethyl) methacrylamide, N-(2-(diethylamino)ethyl) methacrylamide, N-(3-(dimethylamino)propyl) methacrylamide, N-(3-(diethylamino)propyl) methacrylamide, 3-(diethylamino)propyl vinyl ether, 3-(dimethylamino)propyl vinyl ether and combinations thereof.

In non-limiting illustrative embodiments, as may be combined with one or more of the preceding paragraphs, the cationic-forming polymer is a zwitterionic polymer.

In non-limiting illustrative embodiments, as may be combined with one or more of the preceding paragraphs, the zwitterionic polymer is a phosphorylcholine polymer comprising a copolymer of a phosphorylcholine comonomer and a second comonomer.

In non-limiting illustrative embodiments, as may be combined with one or more of the preceding paragraphs, the phosphorylcholine polymer comprises a copolymer of a phosphorylcholine (meth)acrylate or (meth)acrylamide and a C₁ to C₂₅ alkyl (meth)acrylate or (meth)acrylamide.

According to yet another aspect of the present disclosure, a packaging system for the storage of a contact lens comprising a sealed container containing the contact lens according to claims 1-21 immersed in an aqueous packaging solution, wherein the aqueous packaging solution has an osmolality of at least about 200 mOsm/kg, a pH of about 6 to about 9 and is sterilized.

According to still yet another aspect of the present disclosure, a method of preparing a package comprising a storable, sterile ophthalmic device, the method comprises:
(a) immersing an unused contact lens which is a polymerization product of a contact lens-forming monomeric mixture comprising (i) one or more contact lens-forming monomers, and (ii) one of one or more anioinic comfort agents or one of a cationic monomer, a cationic polymer, a cationic-forming monomer or a cationic-forming polymer in an aqueous packaging solution comprising the other one of the one or more anioinic comfort agents or the one of a cationic monomer, a cationic polymer, a cationic-forming monomer or a cationic-forming polymer, wherein the aqueous packaging solution has an osmolality of at least about 200 mOsm/kg and a pH in the range of about 6 to about 9,
(b) packaging the aqueous packaging solution and the unused contact lens in a manner preventing contamination of the contact lens by microorganisms, and
(c) sterilizing the packaged aqueous solution and the unused contact lens.

In non-limiting illustrative embodiments, as may be combined with one or more of the preceding paragraphs, the one or more anionic comfort agents comprise a polymer containing carboxylic acid functionality.

In non-limiting illustrative embodiments, as may be combined with one or more of the preceding paragraphs, the polymer containing carboxylic acid functionality comprises a polymer containing poly(acrylic acid).

In non-limiting illustrative embodiments, as may be combined with one or more of the preceding paragraphs, the one or more anionic comfort agents comprise one or more glycosaminoglycans.

In non-limiting illustrative embodiments, as may be combined with one or more of the preceding paragraphs, the one or more glycosaminoglycans are selected from the group consisting of chondroitin, chondroitin sulfate, dermatan, dermatan sulfate, heparin, heparan sulfate, hyaluronan and hyaluronic acid or a salt thereof.

In non-limiting illustrative embodiments, as may be combined with one or more of the preceding paragraphs, the one or more anionic comfort agents are associated with the cationic monomer.

In non-limiting illustrative embodiments, as may be combined with one or more of the preceding paragraphs, the cationic monomer is a (meth)acrylated cationic monomer or a (meth)acrylamide cationic monomer.

In non-limiting illustrative embodiments, as may be combined with one or more of the preceding paragraphs, the cationic monomer comprises a cationic nitrogen-containing moiety.

In non-limiting illustrative embodiments, as may be combined with one or more of the preceding paragraphs, the cationic monomer is represented by a structure of the following formula:

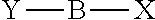

wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

In non-limiting illustrative embodiments, as may be combined with one or more of the preceding paragraphs, X is a group of the general formula:

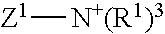

wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl.

In non-limiting illustrative embodiments, as may be combined with one or more of the preceding paragraphs, the cationic monomer is selected from the group consisting of methacrylamidopropyltrimethyl ammonium chloride (MAPTAC), acryloyloxyethyl trimethyl ammonium chloride (AETAC), methacryloyloxyethyl trimethyl ammonium chloride (METAC), dimethylaminopropyl methacrylate (DMAPMA), N-(2-(acryloyloxy)ethyl)-N,N-dimethyldodecan-1-aminium bromide, N-hexyl-11-(methacryloyloxy)-N,N-dimethylundecan-1-aminium bromide, N-benzyl-3-methacrylamido-N,N-dimethylpropan-1-aminium bromide, N-benzyl-12-(methacryloyloxy)-N,N-dimethyldodecan-1-aminium bromide 4-methyl-3-oxopent-4-en-1-yl (2-(trimethylammonio)ethyl) phosphate (MPC) and mixtures thereof.

In non-limiting illustrative embodiments, as may be combined with one or more of the preceding paragraphs, the cationic monomer or the cationic polymer is derived from a cationic-forming monomer or a cationic-forming polymer.

In non-limiting illustrative embodiments, as may be combined with one or more of the preceding paragraphs, the cationic-forming monomer or the cationic-forming polymer is a (meth)acrylated cationic-forming monomer, a (meth)acrylated cationic-forming polymer, (meth)acrylamide cationic-forming monomer or a (meth)acrylamide cationic-forming polymer.

In non-limiting illustrative embodiments, as may be combined with one or more of the preceding paragraphs, the cationic-forming monomer is a (meth)acrylated acyclic tertiary amine monomer.

In non-limiting illustrative embodiments, as may be combined with one or more of the preceding paragraphs, the (meth)acrylated acyclic tertiary amine monomer is selected from the group consisting of 2-(dimethylamino)ethyl acrylate, 2-(diethylamino)ethyl acrylate, 3-(dimethylamino)propyl acrylate, 3-(diethylamino)propyl acrylate, 2-(dimethylamino)ethyl methacrylate, 2-(diethylamino)ethyl methacrylate, 3-(dimethylamino)propyl methacrylate (DMAPMA), or 3-(diethylamino)propyl methacrylate, N-(2-(dimethylamino)ethyl) acrylamide, or N-(2-(diethylamino)ethyl) acrylamide, N-(3-(dimethylamino)propyl) acrylamide, N-(3-(diethylamino)propyl) acrylamide, N-(2-(dimethylamino)ethyl) methacrylamide, N-(2-(diethylamino)ethyl) methacrylamide, N-(3-(dimethylamino)propyl) methacrylamide, N-(3-(diethylamino)propyl) methacrylamide, 3-(diethylamino)propyl vinyl ether, 3-(dimethylamino)propyl vinyl ether and combinations thereof.

In non-limiting illustrative embodiments, as may be combined with one or more of the preceding paragraphs, the cationic-forming polymer is a zwitterionic polymer.

In non-limiting illustrative embodiments, as may be combined with one or more of the preceding paragraphs, the zwitterionic polymer is a phosphorylcholine polymer comprising a copolymer of a phosphorylcholine comonomer and a second comonomer.

In non-limiting illustrative embodiments, as may be combined with one or more of the preceding paragraphs, the phosphorylcholine polymer comprises a copolymer of a phosphorylcholine (meth)acrylate or (meth)acrylamide and a C₁ to C₂₅ alkyl (meth)acrylate or (meth)acrylamide.

In non-limiting illustrative embodiments, as may be combined with one or more of the preceding paragraphs, the sterilizing the packaged aqueous solution and the contact lens comprises autoclaving.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A packaging system for the storage of a contact lens comprising a sealed container containing an unused contact lens comprising one or more anionic comfort agents associated with a cationic monomer or a cationic polymer immersed in an aqueous packaging solution, wherein the aqueous packaging solution has an osmolality of at least about 200 mOsm/kg, a pH of about 6 to about 9 and is sterilized.

2. The packaging system according to claim 1, wherein the one or more anionic comfort agents comprise a polymer containing carboxylic acid functionality.

3. The packaging system according to claim 2, wherein the polymer containing carboxylic acid functionality comprises a polymer containing poly(acrylic acid).

4. The packaging system according to claim 1, wherein the one or more anionic comfort agents comprise one or more glycosaminoglycans.

5. Thee packaging system according to claim 4, wherein the one or more glycosaminoglycans are selected from the group consisting of chondroitin, chondroitin sulfate, dermatan, dermatan sulfate, heparin, heparan sulfate, hyaluronan and hyaluronic acid or a salt thereof.

6. The packaging system according to claim 1, wherein the one or more anionic comfort agents are associated with the cationic monomer.

7. The packaging system according to claim 6, wherein the cationic monomer is a (meth)acrylated cationic monomer or a (meth)acrylamide cationic monomer.

8. The packaging system according to claim 6, wherein the cationic monomer is represented by a structure of the following formula: 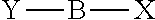
wherein B is a bond, a straight or branched, substituted or unsubstituted alkylene, substituted or unsubstituted oxaalkylene, or substituted or unsubstituted oligooxaalkylene chain; X is a group bearing a center of permanent positive charge and Y is an ethylenically unsaturated polymerizable group.

9. The packaging system according to claim 8, wherein X is a group of the general formula: 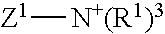
wherein Z¹ is a substituted or unsubstituted alkylene group of 1 to about 12 carbon atoms, substituted or unsubstituted disubstituted-arylene group, substituted or unsubstituted alkylene arylene group, substituted or unsubstituted arylene alkylene group, substituted or unsubstituted alkylene aryl alkylene group, substituted or unsubstituted cycloalkylene group, substituted or unsubstituted alkylene cycloalkyl group, substituted or unsubstituted cycloalkyl alkylene group or substituted or unsubstituted alkylene cycloalkyl alkylene group; and R¹ independently is a substituted or unsubstituted alkyl group of 1 to 4 carbon atoms, or substituted or unsubstituted C₇-C₃₀ alkaryl, or substituted or unsubstituted C₆-C₁₂ aryl.

10. The packaging system according to claim 1, wherein the one or more anionic comfort agents are associated with the cationic polymer.

11. The packaging system according to claim 10, wherein the cationic-forming polymer is a zwitterionic polymer.

12. The packaging system according to claim 11, wherein the zwitterionic polymer is a phosphorylcholine polymer comprising a copolymer of a phosphorylcholine comonomer and a second comonomer.

13. The packaging system according to claim 12, wherein the phosphorylcholine polymer comprises a copolymer of a phosphorylcholine (meth)acrylate or (meth)acrylamide and a C₁ to C₂₅ alkyl (meth)acrylate or (meth)acrylamide.

14. The packaging system according to claim 1, wherein the cationic monomer or the cationic polymer is derived from a cationic-forming monomer or a cationic-forming polymer.

15. The packaging system according to claim 14, wherein the cationic-forming monomer or the cationic-forming polymer is a (meth)acrylated cationic-forming monomer, a (meth)acrylated cationic-forming polymer, (meth)acrylamide cationic-forming monomer or a (meth)acrylamide cationic-forming polymer.

16. The packaging system according to claim 14, wherein the cationic-forming monomer is an acyclic tertiary amine monomer.

17. The packaging system according to claim 16, wherein the acyclic tertiary amine monomer is a (meth)acrylated acyclic tertiary amine monomer.

18. A method of preparing a package comprising a storable, sterile contact lens, the method comprising:
(a) immersing an unused contact lens which is a polymerization product of a contact lens-forming monomeric mixture comprising (i) one or more contact lens-forming monomers, and (ii) one of one or more anioinic comfort agents or one of a cationic monomer, a cationic polymer, a cationic-forming monomer or a cationic-forming polymer in an aqueous packaging solution comprising the other one of the one or more anioinic comfort agents or the one of a cationic monomer, a cationic polymer, a cationic-forming monomer or a cationic-forming polymer, wherein the aqueous packaging solution has an osmolality of at least about 200 mOsm/kg and a pH in the range of about 6 to about 9;
(b) packaging the aqueous packaging solution and the unused contact lens in a manner preventing contamination of the contact lens by microorganisms; and
(c) sterilizing the packaged aqueous solution and the unused contact lens.

19. The method according to claim 18, wherein the one or more anionic comfort agents comprise one of a polymer containing poly(acrylic acid) or a glycosaminoglycan.

20. The method according to claim 18, wherein the cationic monomer is a (meth)acrylated cationic monomer or a (meth)acrylamide cationic monomer and the cationic polymer is a (meth)acrylated cationic polymer or a (meth)acrylamide cationic polymer.
